(19) United States
(12) Patent Application Publication
(10) Pub. No.: US 2025/0258363 A1
(43) Pub. Date: Aug. 14, 2025

(54) VARIABLE MAGNIFICATION OPTICAL SYSTEM, OPTICAL DEVICE, AND METHOD FOR MANUFACTURING VARIABLE MAGNIFICATION OPTICAL SYSTEM

(71) Applicant: NIKON CORPORATION, Tokyo (JP)

(72) Inventors: Kosuke MACHIDA, Tokyo (JP); Tomonori Kuribayashi, Tokyo (JP)

(21) Appl. No.: 19/194,828

(22) Filed: Apr. 30, 2025

Related U.S. Application Data
(63) Continuation of application No. PCT/JP2023/038491, filed on Oct. 25, 2023.

(30) Foreign Application Priority Data
Nov. 4, 2022 (JP) 2022-177062

(51) Int. Cl. G02B 15/14; G02B 15/167

(52) U.S. Cl. CPC G02B 15/1455; G02B 15/1461; G02B 15/167

(57) ABSTRACT

A variable magnification optical system including, in order from an object side, a first lens group having positive refractive power, a second lens group having negative refractive power, a third lens group having positive refractive power, and a subsequent lens group including a plurality of lens groups is configured so that at varying magnification, the first and third lens groups are fixed with respect to an image plane, and the spacings between adjacent lens groups are varied, and that the following conditional expression is satisfied:

0.24<(TL/f1)/(ft/fw)<0.55

where TL is the distance from a lens surface closest to the object side to the image plane, f1 is the focal length of the first lens group, ft is the focal length of the variable magnification optical system in a telephoto end state, and fw is the focal length of the variable magnification optical system in a wide-angle end state.

### CROSS-REFERENCE TO RELATED APPLICATIONS

This application is a continuation of International Patent Application No. PCT/JP2023/038491 filed Oct. 25, 2023, which claims priority from Japanese Patent Application No. 2022-177062 filed Nov. 4, 2022, which are incorporated herein by reference.

### FIELD

The present disclosure relates to a variable magnification optical system, an optical device, and a method for manufacturing a variable magnification optical system.

### BACKGROUND

Variable magnification optical systems used in optical devices, such as cameras for photographs, electronic still cameras, and video cameras, have been proposed (see, e.g., Japanese Unexamined Patent Publication No. 2021-189401).

### SUMMARY

A variable magnification optical system of the present disclosure includes, in order from an object side, a first lens group having positive refractive power, a second lens group having negative refractive power, a third lens group having positive refractive power, and a subsequent lens group including a plurality of lens groups: at varying magnification, the first and third lens groups are fixed with respect to an image plane, and the spacings between adjacent lens groups are varied: the variable magnification optical system satisfies the following conditional expression.

$$0.24 < ( TL / f 1 ) / ( ft / fw ) < 0.55$$

where
TL: the distance from a lens surface closest to the object side to the image plane
f1: the focal length of the first lens group
ft: the focal length of the variable magnification optical system in a telephoto end state
fw: the focal length of the variable magnification optical system in a wide-angle end state

A method for manufacturing a variable magnification optical system of the present disclosure includes configuring a variable magnification optical system including, in order from an object side, a first lens group having positive refractive power, a second lens group having negative refractive power, a third lens group having positive refractive power, and a subsequent lens group including a plurality of lens groups so that at varying magnification, the first and third lens groups are fixed with respect to an image plane, and the spacings between adjacent lens groups are varied, and that the following conditional expression is satisfied.

0.24<(TL/f1)/(ft/fw)<0.55

where
TL: the distance from a lens surface closest to the object side to the image plane
f1: the focal length of the first lens group
ft: the focal length of the variable magnification optical system in a telephoto end state
fw: the focal length of the variable magnification optical system in a wide-angle end state

### BRIEF DESCRIPTION OF DRAWINGS

FIG. 1 is a cross-sectional view of a variable magnification optical system of a first example focusing on an object at infinity in the wide-angle end state.

FIG. 2A shows aberrations of the variable magnification optical system of the first example focusing on an object at infinity in the wide-angle end state, and FIG. 2B shows aberrations of the variable magnification optical system of the first example focusing on an object at infinity in the telephoto end state.

FIG. 3 is a cross-sectional view of a variable magnification optical system of a second example focusing on an object at infinity in the wide-angle end state.

FIG. 4A shows aberrations of the variable magnification optical system of the second example focusing on an object at infinity in the wide-angle end state, and FIG. 4B shows aberrations of the variable magnification optical system of the second example focusing on an object at infinity in the telephoto end state.

FIG. 5 is a cross-sectional view of a variable magnification optical system of a third example focusing on an object at infinity in the wide-angle end state.

FIG. 6A shows aberrations of the variable magnification optical system of the third example focusing on an object at infinity in the wide-angle end state, and FIG. 6B shows aberrations of the variable magnification optical system of the third example focusing on an object at infinity in the telephoto end state.

FIG. 7 is a cross-sectional view of a variable magnification optical system of a fourth example focusing on an object at infinity in the wide-angle end state.

FIG. 8A shows aberrations of the variable magnification optical system of the fourth example focusing on an object at infinity in the wide-angle end state, and FIG. 8B shows aberrations of the variable magnification optical system of the fourth example focusing on an object at infinity in the telephoto end state.

FIG. 9 is a cross-sectional view of a variable magnification optical system of a fifth example focusing on an object at infinity in the wide-angle end state.

FIG. 10A shows aberrations of the variable magnification optical system of the fifth example focusing on an object at infinity in the wide-angle end state, and FIG. 10B shows aberrations of the variable magnification optical system of the fifth example focusing on an object at infinity in the telephoto end state.

FIG. 11 is a cross-sectional view of a variable magnification optical system of a sixth example focusing on an object at infinity in the wide-angle end state.

FIG. 12A shows aberrations of the variable magnification optical system of the sixth example focusing on an object at infinity in the wide-angle end state, and FIG. 12B shows aberrations of the variable magnification optical system of the sixth example focusing on an object at infinity in the telephoto end state.

FIG. 13 schematically shows a camera including a variable magnification optical system of the embodiment.

FIG. 14 is a flowchart outlining a method for manufacturing a variable magnification optical system of the embodiment.

### DESCRIPTION OF EMBODIMENTS

The following describes a variable magnification optical system, an optical device, and a method for manufacturing a variable magnification optical system of an embodiment of the present application.

A variable magnification optical system of the present embodiment includes, in order from an object side, a first lens group having positive refractive power, a second lens group having negative refractive power, a third lens group having positive refractive power, and a subsequent lens group including a plurality of lens groups: at varying magnification, the first and third lens groups are fixed with respect to an image plane, and the spacings between adjacent lens groups are varied: the variable magnification optical system satisfies the following conditional expression.

$$0.24 < ( TL / f 1 ) / ( ft / fw ) < 0.55 \qquad ( 1 )$$

where
TL: the distance from a lens surface closest to the object side to the image plane
f1: the focal length of the first lens group
ft: the focal length of the variable magnification optical system in a telephoto end state
fw: the focal length of the variable magnification optical system in a wide-angle end state

The variable magnification optical system of the present embodiment can reduce variations in aberrations, including spherical aberration at varying magnification, by including a first lens group having positive refractive power, a second lens group having negative refractive power, a third lens group having positive refractive power, and a subsequent lens group including a plurality of lens groups.

Conditional expression (1) restricts the ratio between the ratio of the distance from a lens surface closest to the object side to the image plane to the focal length of the first lens group and the ratio of the focal length of the variable magnification optical system in a telephoto end state to that of the variable magnification optical system in a wide-angle end state (variable power ratio). The variable magnification optical system of the present embodiment satisfying conditional expression (1) can reduce variations in aberrations, including spherical aberration at varying magnification.

If the value of conditional expression (1) exceeds the upper limit in the variable magnification optical system of the present embodiment, the first lens group will have too strong refractive power with respect to the distance from a lens surface closest to the object side to the image plane and the variable power ratio, making it difficult to reduce variations in aberrations, including spherical aberration at varying magnification.

In the variable magnification optical system of the present embodiment, the effect of the present embodiment can be ensured by setting the upper limit of conditional expression (1) to 0.55. To further ensure the effect of the present embodiment, the upper limit of conditional expression (1) is preferably set to 0.53, more preferably to 0.50.

If the value of conditional expression (1) is below the lower limit in the variable magnification optical system of the present embodiment, the first lens group will have too weak refractive power with respect to the distance from a lens surface closest to the object side to the image plane and the variable power ratio, making it difficult to reduce variations in aberrations, including spherical aberration at varying magnification.

In the variable magnification optical system of the present embodiment, the effect of the present embodiment can be ensured by setting the lower limit of conditional expression (1) to 0.24. To further ensure the effect of the present embodiment, the lower limit of conditional expression (1) is preferably set to 0.28, 0.30, or 0.33, more preferably to 0.36.

The variable magnification optical system of the present embodiment preferably satisfies the following conditional expression.

$$3.00 < f 1 / ( - f 2 ) < 5.80 \qquad ( 2 )$$

where
f2: the focal length of the second lens group

Conditional expression (2) restricts the ratio between the focal lengths of the first and second lens groups. The variable magnification optical system of the present embodiment satisfying conditional expression (2) can reduce variations in aberrations, including coma aberration at varying magnification.

If the value of conditional expression (2) exceeds the upper limit in the variable magnification optical system of the present embodiment, the second lens group will have too strong refractive power, making it difficult to reduce variations in aberrations, including coma aberration at varying magnification.

In the variable magnification optical system of the present embodiment, the effect of the present embodiment can be ensured by setting the upper limit of conditional expression (2) to 5.80. To further ensure the effect of the present embodiment, the upper limit of conditional expression (2) is preferably set to 5.60, more preferably to 5.40.

If the value of conditional expression (2) is below the lower limit in the variable magnification optical system of the present embodiment, the first lens group will have too strong refractive power, making it difficult to reduce variations in aberrations, including coma aberration at varying magnification.

In the variable magnification optical system of the present embodiment, the effect of the present embodiment can be ensured by setting the lower limit of conditional expression (2) to 3.00. To further ensure the effect of the present embodiment, the lower limit of conditional expression (2) is preferably set to 3.30, 3.50, or 3.75, more preferably to 3.90.

The variable magnification optical system of the present embodiment preferably satisfies the following conditional expression.

$$0.45 < f 1 / f 3 < 6.00 \qquad ( 3 )$$

where
f3: the focal length of the third lens group

Conditional expression (3) restricts the ratio between the focal lengths of the first and third lens groups. The variable magnification optical system of the present embodiment satisfying conditional expression (3) can reduce variations in aberrations, including coma aberration at varying magnification.

If the value of conditional expression (3) exceeds the upper limit in the variable magnification optical system of the present embodiment, the third lens group will have too strong refractive power, making it difficult to reduce variations in aberrations, including coma aberration at varying magnification.

In the variable magnification optical system of the present embodiment, the effect of the present embodiment can be ensured by setting the upper limit of conditional expression (3) to 6.00. To further ensure the effect of the present embodiment, the upper limit of conditional expression (3) is preferably set to 5.50, 5.00, 4.80, or 4.50, more preferably to 4.00.

If the value of conditional expression (3) is below the lower limit in the variable magnification optical system of the present embodiment, the first lens group will have too strong refractive power, making it difficult to reduce variations in aberrations, including coma aberration at varying magnification.

In the variable magnification optical system of the present embodiment, the effect of the present embodiment can be ensured by setting the lower limit of conditional expression (3) to 0.45. To further ensure the effect of the present embodiment, the lower limit of conditional expression (3) is preferably set to 0.50 or 0.55, more preferably to 0.60.

In the variable magnification optical system of the present embodiment, the subsequent lens group preferably includes a focusing lens group having negative refractive power and moving at focusing, and the following conditional expression is preferably satisfied.

$$0.30 < f 2 / fF < 1. \qquad ( 4 )$$

where
f2: the focal length of the second lens group
fF: the focal length of the focusing lens group

The variable magnification optical system of the present embodiment can reduce variations in aberrations, including spherical aberration at focusing, by the subsequent lens group including a focusing lens group.

Conditional expression (4) restricts the ratio between the focal lengths of the second lens group and the focusing lens group. The variable magnification optical system of the present embodiment satisfying conditional expression (4) can reduce variations in aberrations, including coma aberration at varying magnification and spherical aberration at focusing.

If the value of conditional expression (4) exceeds the upper limit in the variable magnification optical system of the present embodiment, the focusing lens group will have too strong refractive power, making it difficult to reduce variations in aberrations, including spherical aberration at focusing.

In the variable magnification optical system of the present embodiment, the effect of the present embodiment can be ensured by setting the upper limit of conditional expression (4) to 1.00. To further ensure the effect of the present embodiment, the upper limit of conditional expression (4) is preferably set to 0.90, 0.80, or 0.75, more preferably to 0.70.

If the value of conditional expression (4) is below the lower limit in the variable magnification optical system of the present embodiment, the second lens group will have too strong refractive power, making it difficult to reduce variations in aberrations, including coma aberration at varying magnification.

In the variable magnification optical system of the present embodiment, the effect of the present embodiment can be ensured by setting the lower limit of conditional expression (4) to 0.30. To further ensure the effect of the present embodiment, the lower limit of conditional expression (4) is preferably set to 0.33, more preferably to 0.35.

In the variable magnification optical system of the present embodiment, a final lens group disposed closest to the image plane in the subsequent lens group is preferably fixed with respect to the image plane at varying magnification.

Such a configuration simplifies a mechanism for moving the lens groups at varying magnification, enabling the variable magnification optical system of the present embodiment to be reduced in size and weight.

In the variable magnification optical system of the present embodiment, the subsequent lens group preferably includes a focusing lens group having negative refractive power and moving at focusing and a final lens group disposed closest to the image plane, and the following conditional expression is preferably satisfied.

$$2.00 < \vert fR \vert / ( - fF ) < 100.00 \qquad ( 5 )$$

where
fR: the focal length of the final lens group
fF: the focal length of the focusing lens group

Conditional expression (5) restricts the ratio between the focal lengths of the final lens group and the focusing lens group. The variable magnification optical system of the present embodiment satisfying conditional expression (5) can reduce variations in aberrations, including coma aberration at varying magnification and spherical aberration at focusing.

If the value of conditional expression (5) exceeds the upper limit in the variable magnification optical system of the present embodiment, the focusing lens group will have too strong refractive power, making it difficult to reduce variations in aberrations, including spherical aberration at focusing.

In the variable magnification optical system of the present embodiment, the effect of the present embodiment can be ensured by setting the upper limit of conditional expression (5) to 100.00. To further ensure the effect of the present embodiment, the upper limit of conditional expression (5) is preferably set to 80.00, 65.00, 55.00, 40.00, or 25.00, more preferably to 15.00.

If the value of conditional expression (5) is below the lower limit in the variable magnification optical system of the present embodiment, the final lens group will have too strong refractive power, making it difficult to reduce variations in aberrations, including coma aberration at varying magnification.

In the variable magnification optical system of the present embodiment, the effect of the present embodiment can be ensured by setting the lower limit of conditional expression (5) to 2.00. To further ensure the effect of the present embodiment, the lower limit of conditional expression (5) is preferably set to 2.30 or 2.50, more preferably to 2.70.

The variable magnification optical system of the present embodiment preferably satisfies the following conditional expression.

$$1.5 < BFw / fw < 0.95 \qquad ( 6 )$$

where
BFw: the back focal length of the variable magnification optical system focusing on infinity in the wide-angle end state

Conditional expression (6) restricts the ratio between the focal length of the variable magnification optical system in a wide-angle end state and the back focal length of the variable magnification optical system focusing on infinity in the wide-angle end state. The variable magnification optical system of the present embodiment satisfying conditional expression (6) can correct aberrations, including coma aberration at focusing on infinity in the wide-angle end state, favorably.

If the value of conditional expression (6) exceeds the upper limit in the variable magnification optical system of the present embodiment, the back focal length will be large with respect to the focal length in the wide-angle end state, making it difficult to correct aberrations, including coma aberration at focusing on infinity in the wide-angle end state, favorably.

In the variable magnification optical system of the present embodiment, the effect of the present embodiment can be ensured by setting the upper limit of conditional expression (6) to 0.95. To further ensure the effect of the present embodiment, the upper limit of conditional expression (6) is preferably set to 0.92, more preferably to 0.90.

If the value of conditional expression (6) is below the lower limit in the variable magnification optical system of the present embodiment, the back focal length will be small with respect to the focal length in the wide-angle end state, making it difficult to correct aberrations, including coma aberration at focusing on infinity in the wide-angle end state, favorably.

In the variable magnification optical system of the present embodiment, the effect of the present embodiment can be ensured by setting the lower limit of conditional expression (6) to 0.15. To further ensure the effect of the present embodiment, the lower limit of conditional expression (6) is preferably set to 0.20, 0.30, or 0.40, more preferably to 0.45.

The variable magnification optical system of the present embodiment preferably satisfies the following conditional expression.

$$0.08 < BFt / ft < 0.24 \qquad ( 7 )$$

where
BFt: the back focal length of the variable magnification optical system focusing on infinity in the telephoto end state

Conditional expression (7) restricts the ratio between the focal length of the variable magnification optical system in a telephoto end state and the back focal length of the variable magnification optical system focusing on infinity in the telephoto end state. The variable magnification optical system of the present embodiment satisfying conditional expression (7) can correct aberrations, including coma aberration at focusing on infinity in the telephoto end state, favorably.

If the value of conditional expression (7) exceeds the upper limit in the variable magnification optical system of the present embodiment, the back focal length will be large with respect to the focal length in the telephoto end state, making it difficult to correct aberrations, including coma aberration at focusing on infinity in the telephoto end state, favorably.

In the variable magnification optical system of the present embodiment, the effect of the present embodiment can be ensured by setting the upper limit of conditional expression (7) to 0.24. To further ensure the effect of the present embodiment, the upper limit of conditional expression (7) is preferably set to 0.22, more preferably to 0.20.

If the value of conditional expression (7) is below the lower limit in the variable magnification optical system of the present embodiment, the back focal length will be small with respect to the focal length in the telephoto end state, making it difficult to correct aberrations, including coma aberration at focusing on infinity in the telephoto end state, favorably.

In the variable magnification optical system of the present embodiment, the effect of the present embodiment can be ensured by setting the lower limit of conditional expression (7) to 0.08. To further ensure the effect of the present embodiment, the lower limit of conditional expression (7) is preferably set to 0.09, more preferably to 0.10.

In the variable magnification optical system of the present embodiment, the plurality of lens groups in the subsequent lens group preferably includes at least one lens group having positive refractive power, and the following conditional expression is preferably satisfied.

$$0.7 < f 1 / fRP < 3.4 \qquad ( 8 )$$

where
fRP: the focal length of a lens group having the strongest refractive power of lens groups included in the subsequent lens group and having positive refractive power

The variable magnification optical system of the present embodiment can reduce variations in aberrations, including coma aberration at varying magnification by the subsequent lens group including at least one lens group having positive refractive power.

Conditional expression (8) restricts the ratio between the focal lengths of the first lens group and a lens group having the strongest refractive power of lens groups included in the subsequent lens group and having positive refractive power. The variable magnification optical system of the present embodiment satisfying conditional expression (8) can reduce variations in aberrations, including coma aberration at varying magnification.

If the value of conditional expression (8) exceeds the upper limit in the variable magnification optical system of the present embodiment, the lens group having the strongest refractive power of lens groups included in the subsequent lens group and having positive refractive power will have too strong refractive power, making it difficult to reduce variations in aberrations, including coma aberration at varying magnification.

In the variable magnification optical system of the present embodiment, the effect of the present embodiment can be ensured by setting the upper limit of conditional expression (8) to 3.40. To further ensure the effect of the present embodiment, the upper limit of conditional expression (8) is preferably set to 3.30, 3.20, or 3.08, more preferably to 3.00.

If the value of conditional expression (8) is below the lower limit in the variable magnification optical system of the present embodiment, the first lens group will have too strong refractive power, making it difficult to reduce variations in aberrations, including coma aberration at varying magnification.

In the variable magnification optical system of the present embodiment, the effect of the present embodiment can be ensured by setting the lower limit of conditional expression (8) to 0.70. To further ensure the effect of the present embodiment, the lower limit of conditional expression (8) is preferably set to 0.72, 0.80, 0.85, or 0.90, more preferably to 0.95.

The variable magnification optical system of the present embodiment preferably satisfies the following conditional expression.

$$0.5 < Gw / Gt < 1.5 \qquad ( 9 )$$

where
Gw: the distance from the lens surface closest to the object side in the variable magnification optical system in the wide-angle end state to the centroid position of the variable magnification optical system
Gt: the distance from the lens surface closest to the object side in the variable magnification optical system in the telephoto end state to the centroid position of the variable magnification optical system

Conditional expression (9) restricts the ratio of the distance from the lens surface closest to the object side in the variable magnification optical system in the wide-angle end state to the centroid position of the variable magnification optical system to the distance from the lens surface closest to the object side in the variable magnification optical system in the telephoto end state to the centroid position of the variable magnification optical system. In the variable magnification optical system of the present embodiment satisfying conditional expression (9), the change in the centroid position at varying magnification will be small, which enhances usability.

When the variable magnification optical system of the present embodiment does not satisfy conditional expression (9), the change in the centroid position at varying magnification will be large, which impairs usability.

In the variable magnification optical system of the present embodiment, the effect of the present embodiment can be ensured by setting the upper limit of conditional expression (9) to 1.50. To further ensure the effect of the present embodiment, the upper limit of conditional expression (9) is preferably set to 1.40, 1.30, 1.20, or 1.10, more preferably to 1.00.

In the variable magnification optical system of the present embodiment, the effect of the present embodiment can be ensured by setting the lower limit of conditional expression (9) to 0.50. To further ensure the effect of the present embodiment, the lower limit of conditional expression (9) is preferably set to 0.60, 0.70, or 0.80, more preferably to 0.90.

The variable magnification optical system of the present embodiment preferably satisfies the following conditional expression.

30.00°<ωw (10)

where
ωw: the semi-field angle of the variable magnification optical system in the wide-angle end state

Conditional expression (10) restricts the semi-field angle of the variable magnification optical system in the wide-angle end state. The variable magnification optical system of the present embodiment satisfying conditional expression (10) can form an image of a wide-spread subject on the image plane.

In the variable magnification optical system of the present embodiment, the effect of the present embodiment can be ensured by setting the lower limit of conditional expression (10) to 30.00°. To further ensure the effect of the present embodiment, the lower limit of conditional expression (10) is preferably set to 34.00°, more preferably to 36.00°.

The variable magnification optical system of the present embodiment preferably satisfies the following conditional expression.

ωt<15.00° (11)

where
ωt: the semi-field angle of the variable magnification optical system in the telephoto end state

Conditional expression (11) restricts the semi-field angle of the variable magnification optical system in the telephoto end state. The variable magnification optical system of the present embodiment satisfying conditional expression (11) can form a large image of a distant subject on the image plane.

In the variable magnification optical system of the present embodiment, the effect of the present embodiment can be ensured by setting the upper limit of conditional expression (11) to 15.00°. To further ensure the effect of the present embodiment, the upper limit of conditional expression (11) is preferably set to 13.00°, more preferably to 12.00°.

A small-sized variable magnification optical system of favorable imaging performance can be achieved by the above configurations.

An optical device of the present embodiment includes a variable magnification optical system configured as described above. This enables achieving an optical device of favorable optical performance.

A method for manufacturing a variable magnification optical system of the present embodiment includes configuring a variable magnification optical system including, in order from an object side, a first lens group having positive refractive power, a second lens group having negative refractive power, a third lens group having positive refractive power, and a subsequent lens group including a plurality of lens groups so that at varying magnification, the first and third lens groups are fixed with respect to an image plane, and the spacings between adjacent lens groups are varied, and that the following conditional expression is satisfied.

$$0.24 < ( TL / f 1 ) / ( ft / fw ) < 0.55 \qquad ( 1 )$$

where
TL: the distance from a lens surface closest to the object side to the image plane
f1: the focal length of the first lens group
ft: the focal length of the variable magnification optical system in a telephoto end state
fw: the focal length of the variable magnification optical system in a wide-angle end state

A variable magnification optical system of favorable optical performance can be manufactured by such a method for manufacturing an optical system.

### NUMERICAL EXAMPLES

Examples of the present application will be described below with reference to the drawings.

### First Example

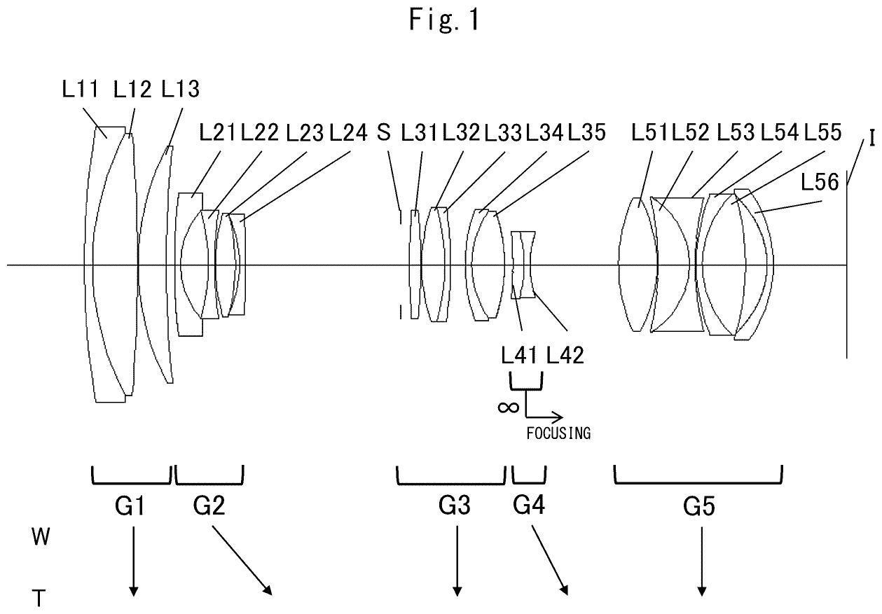

FIG. 1 is a cross-sectional view of a variable magnification optical system of a first example focusing on an object at infinity in the wide-angle end state.

The variable magnification optical system of the present example includes, in order from the object side, a first lens group G1 having positive refractive power, a second lens group G2 having negative refractive power, a third lens group G3 having positive refractive power, a fourth lens group G4 having negative refractive power, and a fifth lens group G5 having positive refractive power.

The first lens group G1 consists of, in order from the object side, a positive cemented lens composed of a meniscus-shaped negative lens L11 convex on the object side and a biconvex positive lens L12, and a meniscus-shaped positive lens L13 convex on the object side.

The second lens group G2 consists of, in order from the object side, a meniscus-shaped negative lens L21 convex on the object side, a biconcave negative lens L22, a biconvex positive lens L23, and a meniscus-shaped negative lens L24 concave on the object side.

The third lens group G3 consists of, in order from the object side, an aperture stop S, a biconvex positive lens L31, a positive cemented lens composed of a biconvex positive lens L32 and a meniscus-shaped negative lens L33 concave on the object side, and a positive cemented lens composed of a meniscus-shaped negative lens L34 convex on the object side and a biconvex positive lens L35.

The fourth lens group G4 consists of a negative cemented lens composed of a meniscus-shaped positive lens L41 concave on the object side and a biconcave negative lens L42.

The fifth lens group G5 consists of, in order from the object side, a biconvex positive lens L51, a negative cemented lens composed of a meniscus-shaped positive lens L52 concave on the object side and a biconcave negative lens L53, a positive cemented lens composed of a meniscus-shaped negative lens L54 convex on the object side and a biconvex positive lens L55, and a meniscus-shaped negative lens L56 concave on the object side.

An imaging device (not shown) constructed from CCD. CMOS, or the like is disposed on an image plane I.

The variable magnification optical system of the present example focuses by moving the fourth lens group G4 along the optical axis. When focus is shifted from infinity to a nearby object, the fourth lens group G4 moves from the object side toward the image plane side.

In the variable magnification optical system of the present example, the fourth lens group G4 and the fifth lens group G5 correspond to the subsequent lens group: the fourth lens group G4 corresponds to the focusing lens group: the fifth lens group G5 corresponds to the final lens group. The fifth lens group G5 corresponds to the lens group having the strongest refractive power of lens groups included in the subsequent lens group and having positive refractive power.

Table 1 below shows specifications of the variable magnification optical system of the present example.

In [General specifications]. TL is the distance from a lens surface closest to the object side to the image plane: fw is the focal length of the whole system in the wide-angle end state: ft is the focal length of the whole system in the telephoto end state: FNOw is the f-number in the wide-angle end state: FNOt is the f-number in the telephoto end state; ww is the semi-field angle (degrees) in the wide-angle end state; ωt is the semi-field angle (degrees) in the telephoto end state: Y is the maximum image height.

In [Lens specifications], m denotes the numbers of optical surfaces counted from the object side, r the radii of curvature, d the surface-to-surface distances, nd the refractive indices at d-line (wavelength 587.6 nm), and νd the Abbe numbers based on d-line. The radius of curvature r=∞ means a plane. In [Lens specifications], the optical surfaces with “*” are aspherical surfaces.

In [Aspherical surface data], m denotes the optical surfaces corresponding to aspherical surface data. K the conic constants, and A4 to A12 the aspherical coefficients.

The aspherical surfaces are expressed by expression (a) below, where y denotes the height in a direction perpendicular to the optical axis, S(y) the distance along the optical axis from the tangent plane at the vertex of an aspherical surface to the aspherical surface at height y (a sag), r the radius of curvature of a reference sphere (paraxial radius of curvature), K the conic constant, and An the nth-order aspherical coefficient. In the examples, the second-order aspherical coefficient A2 is 0. “E-n” means “×10⁻ⁿ.”

$$S ( y ) = ( {y}^{2} / r ) / \{ 1 + {( 1 - K \times {y}^{2} / {r}^{2} )}^{1 / 2} \} + A 4 \times {y}^{4} + A 6 \times {y}^{6} + A 8 \times {y}^{8} + A 10 \times {y}^{10} + A 12 \times {y}^{12} \qquad ( a )$$

The unit of the focal lengths fW and fT, the radii of curvature r, and the other lengths listed in Table 1 is “mm.” However, the values are not limited thereto because the optical performance of a proportionally enlarged or reduced optical system is the same as that of the original optical system.

The above reference symbols in Table 1 will also be used similarly in the tables of the other examples described below.

TABLE 1
[General specifications]

| | |
|---|---|
| TL | 185.45 |
| fw | 28.80 |
| ft | 131.00 |
| FNOw | 4.11 |
| FNOt | 4.12 |
| ωw | 38.46 |
| ωt | 8.68 |
| Y | 21.60 |

[lens specifications]

| m | r | d | nd | vd |
|---|---|---|---|---|
| 1) | 203.5350 | 2.000 | 1.90366 | 31.27 |
| 2) | 66.2025 | 10.955 | 1.59319 | 67.90 |
| 3) | −394.6700 | 0.200 | | |
| 4) | 61.5683 | 6.780 | 1.75500 | 52.34 |
| 5) | 263.3113 | D5 | | |
| *6) | 180.9166 | 1.500 | 1.82098 | 42.50 |
| 7) | 19.6183 | 6.756 | | |
| 8) | −44.0068 | 1.500 | 1.83481 | 42.73 |
| 9) | 82.0673 | 0.200 | | |
| 10) | 43.9489 | 4.902 | 1.80809 | 22.74 |
| 11) | −42.7886 | 0.967 | | |
| 12) | −29.1485 | 1.500 | 1.81600 | 46.59 |
| 13) | −206.5239 | D13 | | |
| 14) | ∞ | 2.000 | | (aperture stop) |
| *15) | 102.6863 | 2.882 | 1.59245 | 66.92 |
| 16) | −108.3264 | 0.200 | | |
| 17) | 44.1156 | 5.502 | 1.59319 | 67.90 |
| 18) | −52.1552 | 1.500 | 1.85883 | 30.00 |
| 19) | −90.3268 | 3.621 | | |
| 20) | 41.9375 | 1.500 | 2.00100 | 29.12 |
| 21) | 22.4452 | 7.995 | 1.55332 | 71.67 |
| *22) | −37.7944 | D22 | | |
| 23) | −101.0979 | 2.706 | 1.94595 | 17.98 |
| 24) | −32.6426 | 1.500 | 1.77387 | 47.25 |
| *25) | 23.4907 | D25 | | |
| 26) | 38.2444 | 9.394 | 1.59319 | 67.90 |
| 27) | −33.7518 | 0.200 | | |
| 28) | −69.6810 | 7.610 | 1.78472 | 25.64 |
| 29) | −19.0000 | 1.500 | 2.00069 | 25.46 |
| 30) | 65.6562 | 0.210 | | |
| 31) | 44.8073 | 1.500 | 1.90366 | 31.27 |
| 32) | 23.5000 | 10.489 | 1.69895 | 30.13 |
| 33) | −57.9472 | 5.237 | | |
| *34) | −20.4734 | 1.500 | 1.74310 | 49.44 |
| 35) | −30.6723 | D35 | | |

[Aspherical surface data]

| m | K | A4 | A6 | A8 | A10 | A12 |
|---|---|---|---|---|---|---|
| 6) | 1.0000 | 3.202E−06 | −7.029E−09 | 2.763E−11 | −7.583E−14 | 1.181E−16 |
| 15) | 1.0000 | −8.531E−06 | −1.770E−09 | −7.217E−12 | 3.167E−14 | |
| 22) | 1.0000 | 6.339E−06 | −1.292E−08 | 3.068E−11 | −1.100E−14 | |
| 25) | 1.0000 | −6.885E−06 | −3.233E−09 | 1.766E−10 | −1.843E−12 | |
| 34) | 1.0000 | 3.056E−06 | 8.008E−09 | 1.421E−10 | −4.651E−13 | 1.075E−15 |

[Focal length data of groups]

| Groups | First surfaces | Focal lengths |
|---|---|---|
| G1 | 1 | 92.73 |
| G2 | 6 | −17.34 |
| G3 | 14 | 24.62 |
| G4 | 23 | −26.67 |
| G5 | 26 | 96.06 |

[Variable spacing data]

| | At focusing on infinity | | | At focusing nearby | | |
|---|---|---|---|---|---|---|
| | Wide-angle | Midpoint | Telephoto | Wide-angle | Midpoint | Telephoto |
| D5 | 2.000 | 25.493 | 37.799 | 2.000 | 25.493 | 37.799 |
| D13 | 37.799 | 14.305 | 2.000 | 37.799 | 14.305 | 2.000 |
| D22 | 2.000 | 9.389 | 16.869 | 2.153 | 9.804 | 17.740 |
| D25 | 21.523 | 14.134 | 6.655 | 21.370 | 13.720 | 5.783 |
| D35 | 17.828 | 17.828 | 17.828 | 17.828 | 17.828 | 17.828 |

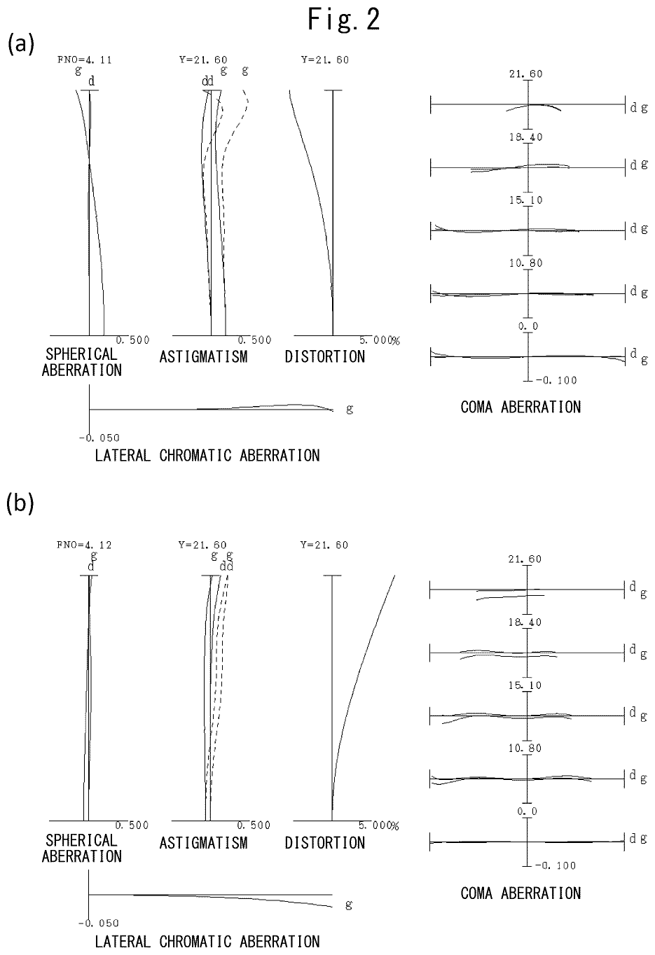

FIG. 2A shows aberrations of the variable magnification optical system of the first example focusing on an object at infinity in the wide-angle end state: FIG. 2B shows aberrations of the variable magnification optical system of the first example focusing on an object at infinity in the telephoto end state.

In the graphs of aberrations, FNO and Y denote f-number and image height, respectively. More specifically, the graph of spherical aberration shows the f-number corresponding to the maximum aperture: the graphs of astigmatism and distortion show the maximum of image height: the graphs of coma aberration show the values of image height. d and g denote d-line and g-line (wavelength 435.8 nm), respectively. In the graph of astigmatism, the solid lines and the broken lines show a sagittal plane and a meridional plane, respectively. The reference symbols in the graphs of aberrations of the present example will also be used in those of the other examples described below.

The graphs of aberrations suggest that the variable magnification optical system of the present example corrects aberrations appropriately and has high optical performance.

### Second Example

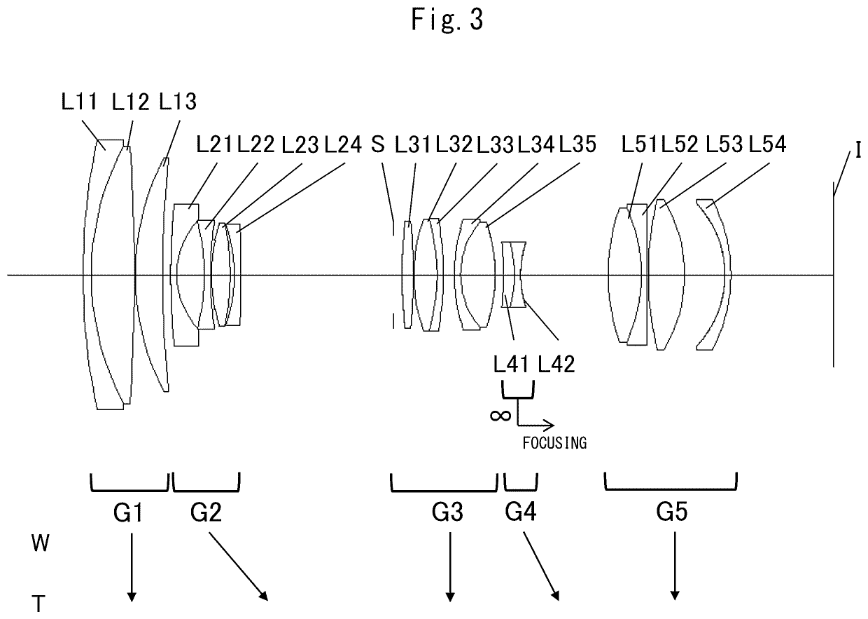

FIG. 3 is a cross-sectional view of a variable magnification optical system of a second example focusing on an object at infinity in the wide-angle end state.

The variable magnification optical system of the present example includes, in order from the object side, a first lens group G1 having positive refractive power, a second lens group G2 having negative refractive power, a third lens group G3 having positive refractive power, a fourth lens group G4 having negative refractive power, and a fifth lens group G5 having positive refractive power.

The first lens group G1 consists of, in order from the object side, a positive cemented lens composed of a meniscus-shaped negative lens L11 convex on the object side and a biconvex positive lens L12, and a meniscus-shaped positive lens L13 convex on the object side.

The second lens group G2 consists of, in order from the object side, a meniscus-shaped negative lens L21 convex on the object side, a biconcave negative lens L22, a biconvex positive lens L23, and a meniscus-shaped negative lens L24 concave on the object side.

The third lens group G3 consists of, in order from the object side, an aperture stop S, a biconvex positive lens L31, a positive cemented lens composed of a biconvex positive lens L32 and a meniscus-shaped negative lens L33 concave on the object side, and a positive cemented lens composed of a meniscus-shaped negative lens L34 convex on the object side and a biconvex positive lens L35.

The fourth lens group G4 consists of a negative cemented lens composed of a meniscus-shaped positive lens L41 concave on the object side and a biconcave negative lens L42.

The fifth lens group G5 consists of, in order from the object side, a negative cemented lens composed of a biconvex positive lens L51 and a meniscus-shaped negative lens L52 concave on the object side, a biconvex positive lens L53, and a meniscus-shaped negative lens L54 concave on the object side.

An imaging device (not shown) constructed from CCD, CMOS, or the like is disposed on an image plane I.

The variable magnification optical system of the present example focuses by moving the fourth lens group G4 along the optical axis. When focus is shifted from infinity to a nearby object, the fourth lens group G4 moves from the object side toward the image plane side.

In the variable magnification optical system of the present example, the fourth lens group G4 and the fifth lens group G5 correspond to the subsequent lens group: the fourth lens group G4 corresponds to the focusing lens group: the fifth lens group G5 corresponds to the final lens group. The fifth lens group G5 corresponds to the lens group having the strongest refractive power of lens groups included in the subsequent lens group and having positive refractive power.

Table 2 below shows specifications of the variable magnification optical system of the present example.

TABLE 2
[General specifications]

| | |
|---|---|
| TL | 185.45 |
| fw | 28.80 |
| ft | 131.00 |
| FNOw | 4.12 |
| FNOt | 4.12 |
| ωw | 38.55 |
| ωt | 8.68 |
| Y | 21.60 |

[lens specifications]

| m | r | d | nd | vd |
|---|---|---|---|---|
| 1) | 160.9680 | 2.000 | 1.85883 | 30.00 |
| 2) | 66.6346 | 10.667 | 1.49782 | 82.57 |
| 3) | −440.7488 | 0.200 | | |
| 4) | 61.6751 | 6.785 | 1.75500 | 52.34 |
| 5) | 270.2573 | D5 | | |
| *6) | 200.0407 | 1.500 | 1.82098 | 42.50 |
| 7) | 19.4035 | 6.813 | | |
| 8) | −50.3925 | 1.500 | 1.81600 | 46.59 |
| 9) | 88.0073 | 0.200 | | |
| 10) | 40.5880 | 4.660 | 1.80809 | 22.74 |
| 11) | −61.3314 | 1.043 | | |
| 12) | −35.5828 | 1.500 | 1.77250 | 49.62 |
| 13) | −1523.3790 | D13 | | |
| 14) | ∞ | 2.000 | | (aperture stop) |
| *15) | 89.0223 | 2.817 | 1.59245 | 66.92 |
| 16) | −138.8020 | 0.200 | | |
| 17) | 43.1800 | 5.721 | 1.59319 | 67.90 |
| 18) | −46.1385 | 1.500 | 2.00069 | 25.46 |
| 19) | −75.7096 | 2.760 | | |
| 20) | 42.7879 | 1.500 | 1.90265 | 35.77 |
| 21) | 19.9289 | 8.552 | 1.55332 | 71.67 |
| *22) | −37.9809 | D22 | | |
| 23) | −91.1448 | 2.782 | 1.94595 | 17.98 |
| 24) | −30.5403 | 1.500 | 1.77387 | 47.25 |
| *25) | 23.7535 | D25 | | |
| 26) | 48.8085 | 8.210 | 1.49782 | 82.57 |
| 27) | −39.8555 | 1.500 | 2.00100 | 29.12 |
| 28) | −1151.4031 | 0.247 | | |
| 29) | 78.5798 | 9.000 | 1.55298 | 55.07 |
| 30) | −35.4446 | 9.937 | | |
| *31) | −25.9824 | 1.500 | 1.74310 | 49.44 |
| 32) | −39.1102 | D32 | | |

[Aspherical surface data]

| m | K | A4 | A6 | A8 | A10 | A12 |
|---|---|---|---|---|---|---|
| 6) | 1.0000 | 2.250E−06 | −6.521E−09 | 2.698E−11 | −8.238E−14 | 1.019E−16 |
| 15) | 1.0000 | −8.797E−06 | −8.208E−11 | −2.286E−11 | 5.285E−14 | |
| 22) | 1.0000 | 4.616E−06 | −1.129E−08 | 2.220E−12 | 2.745E−14 | |
| 25) | 1.0000 | −7.596E−06 | 3.224E−09 | −2.256E−11 | −6.035E−13 | |
| 31) | 1.0000 | −3.031E−06 | −7.979E−09 | 7.173E−11 | −2.277E−13 | 3.068E−16 |

[Focal length data of groups]

| Groups | First surfaces | Focal lengths |
|---|---|---|
| G1 | 1 | 94.25 |
| G2 | 6 | −17.77 |
| G3 | 14 | 24.74 |
| G4 | 23 | −26.42 |
| G5 | 26 | 76.08 |

[Variable spacing data]

| | At focusing on infinity | | | At focusing nearby | | |
|---|---|---|---|---|---|---|
| | Wide-angle | Midpoint | Telephoto | Wide-angle | Midpoint | Telephoto |
| D5 | 2.000 | 25.602 | 37.954 | 2.000 | 25.602 | 37.954 |
| D13 | 37.954 | 14.352 | 2.000 | 37.954 | 14.352 | 2.000 |
| D22 | 2.000 | 9.302 | 16.644 | 2.160 | 9.726 | 17.519 |
| D25 | 21.625 | 14.323 | 6.981 | 21.465 | 13.899 | 6.106 |
| D32 | 25.282 | 25.282 | 25.281 | 25.282 | 25.282 | 25.281 |

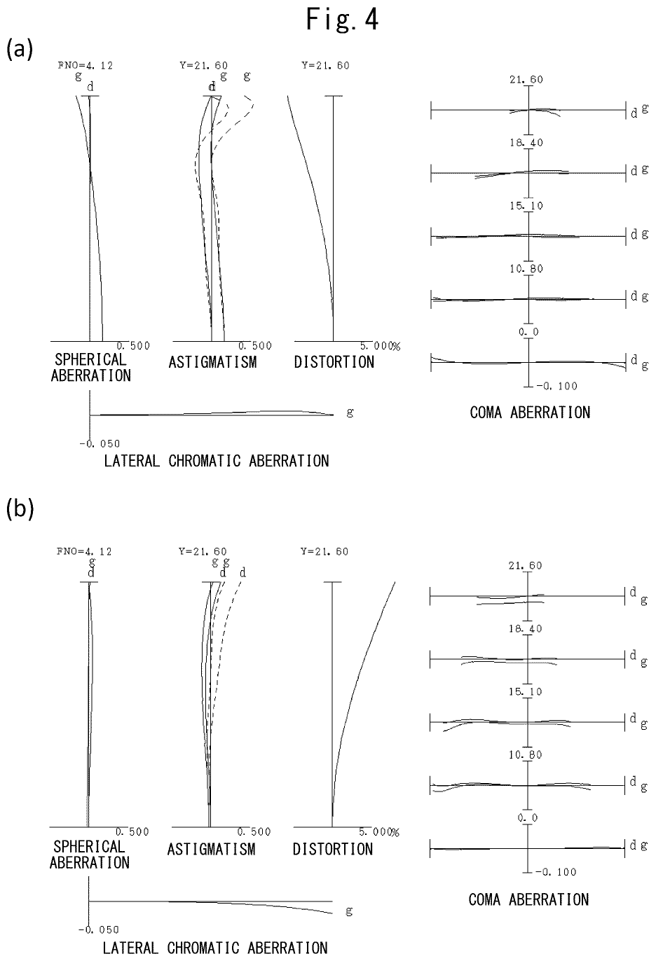

FIG. 4A shows aberrations of the variable magnification optical system of the second example focusing on an object at infinity in the wide-angle end state; FIG. 4B shows aberrations of the variable magnification optical system of the second example focusing on an object at infinity in the telephoto end state.

The graphs of aberrations suggest that the variable magnification optical system of the present example corrects aberrations appropriately and has high optical performance.

### Third Example

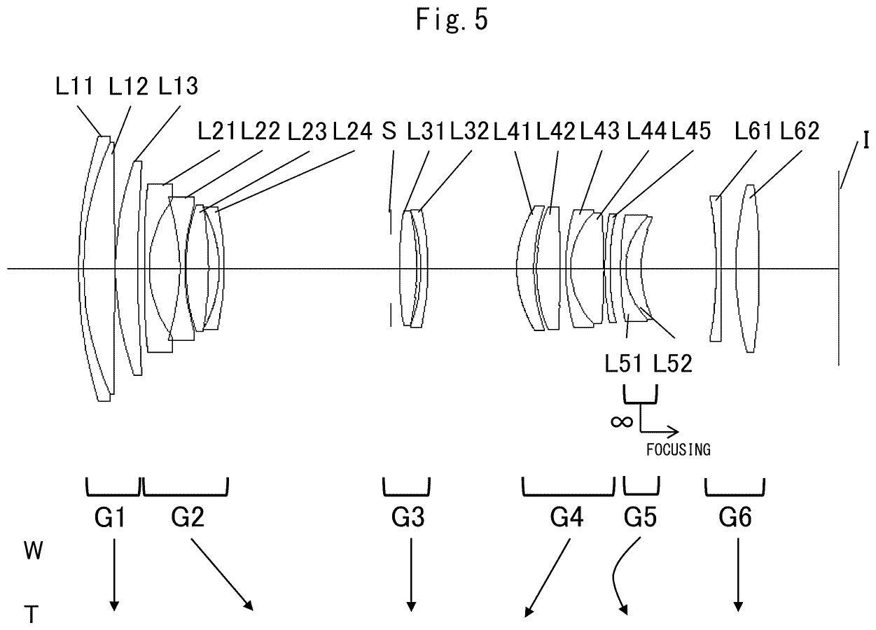

FIG. 5 is a cross-sectional view of a variable magnification optical system of a third example focusing on an object at infinity in the wide-angle end state.

The variable magnification optical system of the present example includes, in order from the object side, a first lens group G1 having positive refractive power, a second lens group G2 having negative refractive power, a third lens group G3 having positive refractive power, a fourth lens group G4 having positive refractive power, a fifth lens group G5 having negative refractive power, and a sixth lens group G6 having positive refractive power.

The first lens group G1 consists of, in order from the object side, a positive cemented lens composed of a meniscus-shaped negative lens L11 convex on the object side and a biconvex positive lens L12, and a meniscus-shaped positive lens L13 convex on the object side.

The second lens group G2 consists of, in order from the object side, a meniscus-shaped negative lens L21 convex on the object side, a biconcave negative lens L22, a biconvex positive lens L23, and a meniscus-shaped negative lens L24 concave on the object side.

The third lens group G3 consists of, in order from the object side, an aperture stop S, a biconvex positive lens L31, and a meniscus-shaped negative lens L32 concave on the object side.

The fourth lens group G4 consists of, in order from the object side, a meniscus-shaped positive lens L41 convex on the object side, a biconvex positive lens L42, a positive cemented lens composed of a meniscus-shaped negative lens L43 convex on the object side and a biconvex positive lens L44, and a meniscus-shaped negative lens L45 convex on the object side.

The fifth lens group G5 consists of a negative cemented lens composed of a meniscus-shaped negative lens L51 convex on the object side and a meniscus-shaped positive lens L52 convex on the object side.

The sixth lens group G6 consists of, in order from the object side, a meniscus-shaped negative lens L61 concave on the object side and a biconvex positive lens L62.

An imaging device (not shown) constructed from CCD, CMOS, or the like is disposed on an image plane I.

The variable magnification optical system of the present example focuses by moving the fifth lens group G5 along the optical axis. When focus is shifted from infinity to a nearby object, the fifth lens group G5 moves from the object side toward the image plane side.

In the variable magnification optical system of the present example, the fourth, fifth, and sixth lens groups G4, G5, and G6 correspond to the subsequent lens group: the fifth lens group G5 corresponds to the focusing lens group: the sixth lens group G6 corresponds to the final lens group. The fourth lens group G4 corresponds to the lens group having the strongest refractive power of lens groups included in the subsequent lens group and having positive refractive power.

Table 3 below shows specifications of the variable magnification optical system of the present example.

TABLE 3
[General specifications]

| | |
|---|---|
| TL | 178.46 |
| fw | 28.84 |
| ft | 130.95 |
| FNOw | 4.12 |
| FNOt | 4.12 |
| ωw | 38.54 |
| ωt | 8.71 |
| Y | 21.60 |

[lens specifications]

| m | r | d | nd | vd |
|---|---|---|---|---|
| 1) | 106.2485 | 1.200 | 1.85451 | 25.15 |
| 2) | 72.9108 | 7.265 | 1.49782 | 82.57 |
| 3) | −2566.3273 | 0.200 | | |
| 4) | 73.1525 | 5.243 | 1.59319 | 67.90 |
| 5) | 311.0755 | D5 | | |
| *6) | 407.0508 | 1.200 | 1.85108 | 40.12 |
| 7) | 26.2159 | 7.148 | | |
| 8) | −51.6266 | 1.200 | 1.72916 | 54.61 |
| 9) | 51.4576 | 0.200 | | |
| 10) | 45.6463 | 5.333 | 1.85451 | 25.15 |
| 11) | −83.8936 | 2.473 | | |
| *12) | −28.9700 | 1.200 | 1.49782 | 82.57 |
| 13) | −65.5471 | D13 | | |
| 14) | ∞ | 2.000 | | (aperture stop) |
| 15) | 95.8245 | 4.041 | 1.59349 | 67.00 |
| 16) | −62.8425 | 0.940 | | |
| 17) | −40.3456 | 1.651 | 1.87070 | 40.74 |
| 18) | −65.9661 | D18 | | |
| *19) | 25.9551 | 4.000 | 1.51680 | 64.14 |
| 20) | 44.4253 | 0.645 | | |
| 21) | 39.9828 | 5.500 | 1.59319 | 67.90 |
| 22) | −391.0917 | 1.331 | | |
| 23) | 48.6465 | 1.200 | 1.90366 | 31.27 |
| 24) | 18.3320 | 7.807 | 1.59319 | 67.90 |
| 25) | −171.4604 | 0.200 | | |
| 26) | 77.7825 | 1.200 | 1.69343 | 53.30 |
| *27) | 73.7764 | D27 | | |
| 28) | 80.7818 | 1.200 | 1.95000 | 29.37 |
| 29) | 16.7054 | 3.578 | 1.94595 | 17.98 |
| 30) | 27.6369 | D30 | | |
| *31) | −101.4351 | 1.200 | 1.85108 | 40.12 |
| 32) | −42069.7150 | 3.381 | | |
| 33) | 73.6536 | 5.500 | 1.54814 | 45.51 |
| 34) | −164.9703 | D34 | | |

[Aspherical surface data]

| m | K | A4 | A6 | A8 | A10 | A12 |
|---|---|---|---|---|---|---|
| 6) | 1.0000 | 2.211E−06 | −1.437E−09 | 1.171E−11 | −2.870E−14 | 5.008E−17 |
| 12) | 1.0000 | −1.225E−07 | −1.735E−09 | −1.015E−11 | | |
| 19) | 1.0000 | −2.831E−06 | −3.190E−09 | −5.738E−12 | −8.899E−15 | |
| 27) | 1.0000 | 1.265E−05 | 1.948E−08 | 1.185E−11 | 2.335E−13 | |
| 31) | 1.0000 | −1.999E−06 | 2.863E−09 | −3.559E−12 | 8.759E−15 | |

[Focal length data of groups]

| Groups | First surfaces | Focal lengths |
|---|---|---|
| G1 | 1 | 105.19 |
| G2 | 6 | −24.34 |
| G3 | 14 | 134.69 |
| G4 | 19 | 35.45 |
| G5 | 28 | −46.01 |
| G6 | 31 | 361.54 |

[Variable spacing data]

| | At focusing on infinity | | | At focusing nearby | | |
|---|---|---|---|---|---|---|
| | Wide-angle | Midpoint | Telephoto | Wide-angle | Midpoint | Telephoto |
| D5 | 1.500 | 22.793 | 38.616 | 1.500 | 22.793 | 38.616 |
| D13 | 39.116 | 17.822 | 2.000 | 39.116 | 17.822 | 2.000 |
| D18 | 20.867 | 4.924 | 2.000 | 20.867 | 4.924 | 2.000 |
| D27 | 2.529 | 4.659 | 10.992 | 2.905 | 5.282 | 12.275 |
| D30 | 17.618 | 31.431 | 28.022 | 17.242 | 30.807 | 26.739 |
| D34 | 18.793 | 18.798 | 18.797 | 18.793 | 18.798 | 18.797 |

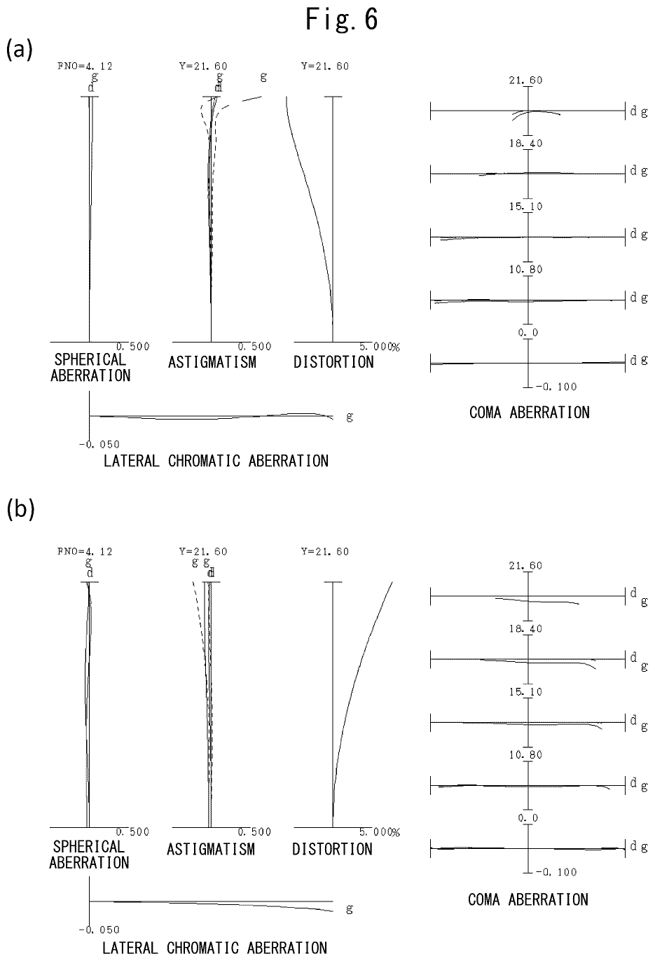

FIG. 6A shows aberrations of the variable magnification optical system of the third example focusing on an object at infinity in the wide-angle end state; FIG. 6B shows aberrations of the variable magnification optical system of the third example focusing on an object at infinity in the telephoto end state.

The graphs of aberrations suggest that the variable magnification optical system of the present example corrects aberrations appropriately and has high optical performance.

### Fourth Example

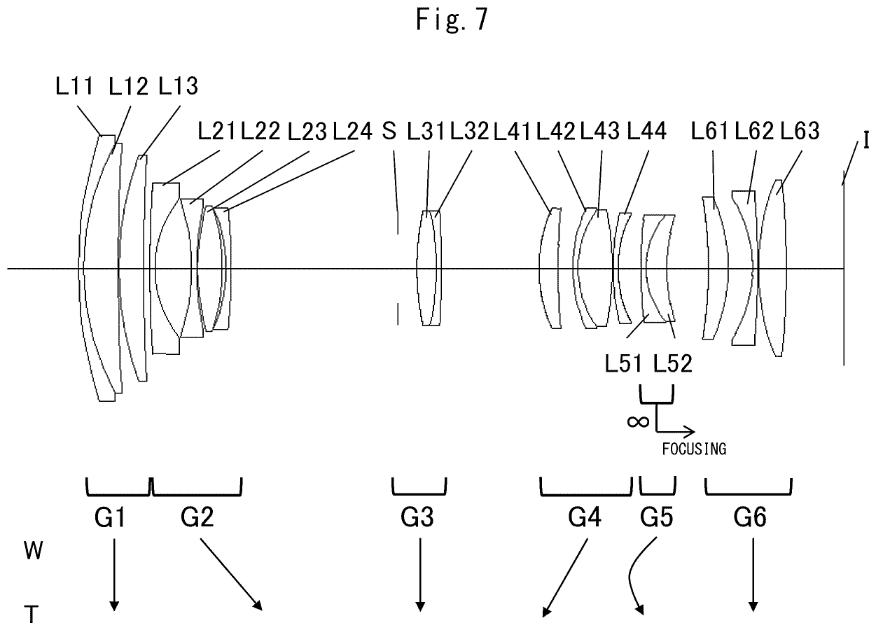

FIG. 7 is a cross-sectional view of a variable magnification optical system of a fourth example focusing on an object at infinity in the wide-angle end state.

The variable magnification optical system of the present example includes, in order from the object side, a first lens group G1 having positive refractive power, a second lens group G2 having negative refractive power, a third lens group G3 having positive refractive power, a fourth lens group G4 having positive refractive power, a fifth lens group G5 having negative refractive power, and a sixth lens group G6 having negative refractive power.

The first lens group G1 consists of, in order from the object side, a positive cemented lens composed of a meniscus-shaped negative lens L11 convex on the object side and a meniscus-shaped positive lens L12 convex on the object side, and a meniscus-shaped positive lens L13 convex on the object side.

The second lens group G2 consists of, in order from the object side, a meniscus-shaped negative lens L21 convex on the object side, a biconcave negative lens L22, a biconvex positive lens L23, and a meniscus-shaped negative lens L24 concave on the object side.

The third lens group G3 consists of, in order from the object side, an aperture stop S and a positive cemented lens composed of a biconvex positive lens L31 and a meniscus-shaped negative lens L32 concave on the object side.

The fourth lens group G4 consists of, in order from the object side, a meniscus-shaped positive lens L41 convex on the object side, a positive cemented lens composed of a meniscus-shaped positive lens L42 convex on the object side and a biconvex positive lens L43, and a meniscus-shaped negative lens L44 convex on the object side.

The fifth lens group G5 consists of a negative cemented lens composed of a meniscus-shaped negative lens L51 convex on the object side and a meniscus-shaped positive lens L52 convex on the object side.

The sixth lens group G6 consists of, in order from the object side, a meniscus-shaped positive lens L61 concave on the object side, a meniscus-shaped negative lens L62 concave on the object side, and a biconvex positive lens L63.

An imaging device (not shown) constructed from CCD, CMOS, or the like is disposed on an image plane I.

The variable magnification optical system of the present example focuses by moving the fifth lens group G5 along the optical axis. When focus is shifted from infinity to a nearby object, the fifth lens group G5 moves from the object side toward the image plane side.

In the variable magnification optical system of the present example, the fourth, fifth, and sixth lens groups G4, G5, and G6 correspond to the subsequent lens group: the fifth lens group G5 corresponds to the focusing lens group: the sixth lens group G6 corresponds to the final lens group. The fourth lens group G4 corresponds to the lens group having the strongest refractive power of lens groups included in the subsequent lens group and having positive refractive power.

Table 4 below shows specifications of the variable magnification optical system of the present example.

TABLE 4
[General specifications]

| | |
|---|---|
| TL | 179.47 |
| fw | 28.84 |
| ft | 130.95 |
| FNOw | 4.12 |
| FNOt | 4.12 |
| ωw | 38.54 |
| ωt | 8.69 |
| Y | 21.60 |

[lens specifications]

| m | r | d | nd | vd |
|---|---|---|---|---|
| 1) | 100.3057 | 1.200 | 1.85451 | 25.15 |
| 2) | 60.8344 | 8.099 | 1.53775 | 74.70 |
| 3) | 469.7604 | 0.200 | | |
| 4) | 76.2982 | 5.766 | 1.75500 | 52.34 |
| 5) | 445.1784 | D5 | | |
| *6) | 489.6863 | 1.200 | 1.85108 | 40.12 |
| 7) | 25.8725 | 8.554 | | |
| 8) | −50.8620 | 1.200 | 1.83481 | 42.72 |
| 9) | 76.2098 | 0.200 | | |
| 10) | 53.6363 | 5.772 | 1.84666 | 23.80 |
| 11) | −47.5523 | 0.904 | | |
| 12) | −34.9057 | 1.200 | 1.74310 | 49.44 |
| *13) | −135.8499 | D13 | | |
| 14) | ∞ | 4.500 | | (aperture stop) |
| *15) | 63.0236 | 4.554 | 1.69343 | 53.30 |
| 16) | −58.8213 | 1.200 | 1.95000 | 29.37 |
| 17) | −207.1161 | D17 | | |
| *18) | 33.7325 | 4.500 | 1.59319 | 67.90 |
| 19) | 153.6733 | 3.481 | | |
| 20) | 33.2491 | 1.200 | 1.90110 | 27.06 |
| 21) | 23.3148 | 8.000 | 1.53775 | 74.70 |
| 22) | −73.6961 | 0.200 | | |
| 23) | 53.2656 | 1.200 | 1.85108 | 40.12 |
| *24) | 30.8637 | D24 | | |
| 25) | 104.0299 | 1.200 | 2.00069 | 25.46 |
| 26) | 18.9870 | 4.800 | 1.94595 | 17.98 |
| 27) | 39.8976 | D27 | | |
| *28) | −103.0331 | 4.657 | 1.69343 | 53.30 |
| 29) | −40.6980 | 5.706 | | |
| 30) | −30.6104 | 1.200 | 1.91082 | 35.25 |
| 31) | −216.9426 | 0.200 | | |
| 32) | 55.8746 | 6.500 | 1.61266 | 44.46 |
| 33) | −211.7306 | D33 | | |

[Aspherical surface data]

| m | K | A4 | A6 | A8 | A10 | A12 |
|---|---|---|---|---|---|---|
| 6) | 1.0000 | 1.488E−06 | −5.065E−10 | 1.818E−12 | 1.359E−15 | |
| 13) | 1.0000 | 2.938E−07 | −7.289E−10 | 1.426E−11 | −2.828E−14 | |
| 15) | 1.0000 | −1.642E−06 | 9.096E−10 | −2.490E−12 | | |
| 18) | 1.0000 | 9.832E−08 | −5.129E−09 | −2.654E−12 | | |
| 24) | 1.0000 | 1.226E−05 | 2.280E−08 | 3.207E−12 | 1.685E−13 | |
| 28) | 1.0000 | −1.332E−06 | 2.889E−09 | 2.329E−12 | | |

[Focal length data of groups]

| Groups | First surfaces | Focal lengths |
|---|---|---|
| G1 | 1 | 97.13 |
| G2 | 6 | −23.47 |
| G3 | 14 | 89.27 |
| G4 | 18 | 44.88 |
| G5 | 25 | −60.88 |
| G6 | 28 | −3286.39 |

[Variable spacing data]

| | At focusing on infinity | | | At focusing nearby | | |
|---|---|---|---|---|---|---|
| | Wide-angle | Midpoint | Telephoto | Wide-angle | Midpoint | Telephoto |
| D5 | 500 | 23.030 | 37.587 | 1.500 | 23.030 | 37.587 |
| D13 | 39.087 | 17.557 | 3.000 | 39.087 | 17.557 | 3.000 |
| D17 | 22.857 | 6.314 | 2.000 | 22.857 | 6.314 | 2.000 |
| D24 | 5.350 | 6.250 | 11.401 | 6.000 | 7.252 | 13.341 |
| D27 | 9.813 | 25.456 | 24.618 | 9.162 | 24.454 | 22.679 |
| D33 | 13.468 | 13.469 | 13.458 | 13.468 | 13.469 | 13.458 |

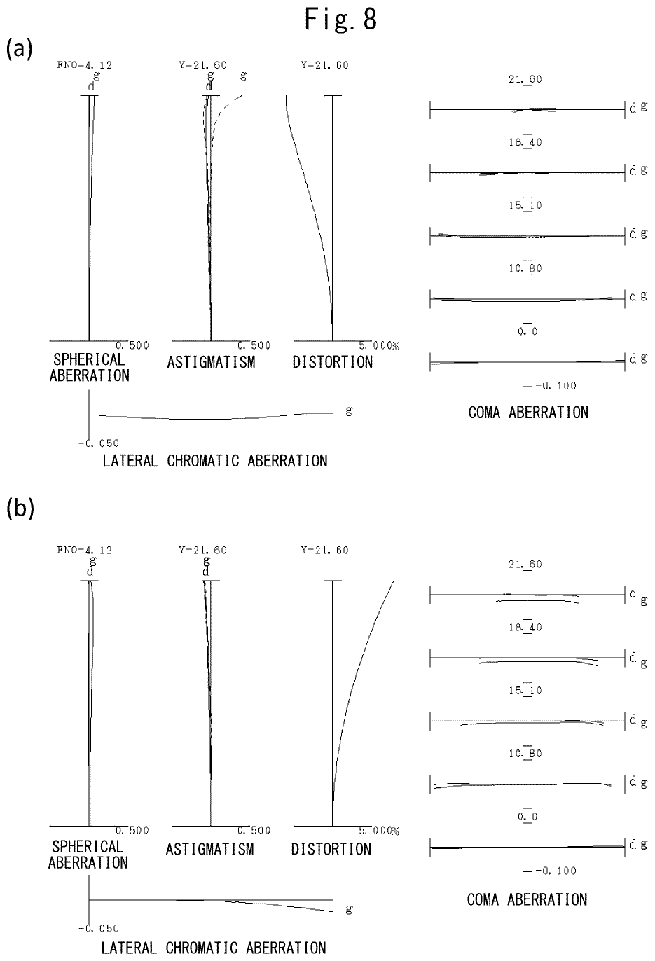

FIG. 8A shows aberrations of the variable magnification optical system of the fourth example focusing on an object at infinity in the wide-angle end state: FIG. 8B shows aberrations of the variable magnification optical system of the fourth example focusing on an object at infinity in the telephoto end state.

The graphs of aberrations suggest that the variable magnification optical system of the present example corrects aberrations appropriately and has high optical performance.

### Fifth Example

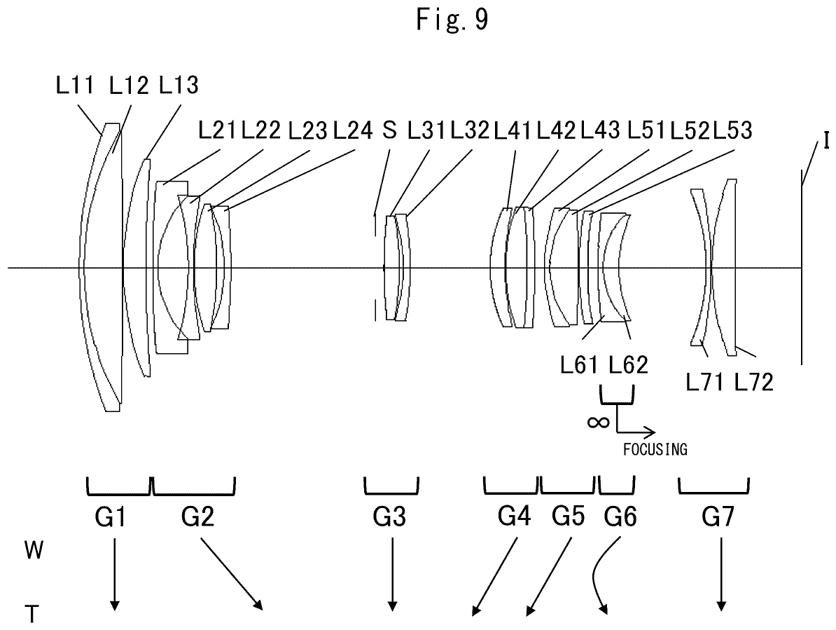

FIG. 9 is a cross-sectional view of a variable magnification optical system of a fifth example focusing on an object at infinity in the wide-angle end state.

The variable magnification optical system of the present example includes, in order from the object side, a first lens group G1 having positive refractive power, a second lens group G2 having negative refractive power, a third lens group G3 having positive refractive power, a fourth lens group G4 having positive refractive power, a fifth lens group G5 having positive refractive power, a sixth lens group G6 having negative refractive power, and a seventh lens group G7 having positive refractive power.

The first lens group G1 consists of, in order from the object side, a positive cemented lens composed of a meniscus-shaped negative lens L11 convex on the object side and a biconvex positive lens L12, and a meniscus-shaped positive lens L13 convex on the object side.

The second lens group G2 consists of, in order from the object side, a meniscus-shaped negative lens L21 convex on the object side, a biconcave negative lens L22, a biconvex positive lens L23, and a meniscus-shaped negative lens L24 concave on the object side.

The third lens group G3 consists of, in order from the object side, an aperture stop S, a biconvex positive lens L31, and a meniscus-shaped negative lens L32 concave on the object side.

The fourth lens group G4 consists of, in order from the object side, a meniscus-shaped positive lens L41 convex on the object side and a positive cemented lens composed of a biconvex positive lens L42 and a meniscus-shaped negative lens L43 concave on the object side.

The fifth lens group G5 consists of a positive cemented lens composed of a meniscus-shaped negative lens L51 convex on the object side and a biconvex positive lens L52, and a meniscus-shaped positive lens L53 convex on the object side.

The sixth lens group G6 consists of a negative cemented lens composed of a meniscus-shaped negative lens L61 convex on the object side and a meniscus-shaped positive lens L62 convex on the object side.

The seventh lens group G7 consists of, in order from the object side, a meniscus-shaped negative lens L71 concave on the object side and a meniscus-shaped positive lens L72 convex on the object side.

An imaging device (not shown) constructed from CCD, CMOS, or the like is disposed on an image plane I.

The variable magnification optical system of the present example focuses by moving the sixth lens group G6 along the optical axis. When focus is shifted from infinity to a nearby object, the sixth lens group G6 moves from the object side toward the image plane side.

In the variable magnification optical system of the present example, the fourth, fifth, sixth, and seventh lens groups G4, G5, G6, and G7 correspond to the subsequent lens group; the sixth lens group G6 corresponds to the focusing lens group; the seventh lens group G7 corresponds to the final lens group. The fourth lens group G4 corresponds to the lens group having the strongest refractive power of lens groups included in the subsequent lens group and having positive refractive power.

Table 5 below shows specifications of the variable magnification optical system of the present example.

TABLE 5
[General specifications]

| | |
|---|---|
| TL | 169.45 |
| fw | 28.84 |
| ft | 116.40 |
| FNOw | 4.12 |
| FNOt | 4.12 |
| ωw | 38.52 |
| ωt | 9.80 |
| Y | 21.60 |

[lens specifications]

| m | r | d | nd | vd |
|---|---|---|---|---|
| 1) | 93.2961 | 1.200 | 1.85451 | 25.15 |
| 2) | 64.7090 | 8.994 | 1.49782 | 82.57 |
| 3) | −1632.1248 | 0.200 | | |
| 4) | 69.0153 | 5.266 | 1.59319 | 67.90 |
| 5) | 278.2695 | D5 | | |
| *6) | 315.4615 | 1.200 | 1.77387 | 47.25 |
| 7) | 23.3642 | 7.183 | | |
| 8) | −56.9381 | 1.200 | 1.83481 | 42.73 |
| 9) | 89.0147 | 0.200 | | |
| 10) | 48.2552 | 5.210 | 1.84666 | 23.80 |
| 11) | −77.2530 | 1.839 | | |
| 12) | −33.1241 | 1.500 | 1.59319 | 67.90 |
| 13) | −166.5029 | D13 | | |
| 14) | ∞ | 2.000 | | (aperture stop) |
| *15) | 103.5679 | 3.610 | 1.69343 | 53.30 |
| 16) | −65.2717 | 0.920 | | |
| 17) | −38.6388 | 1.605 | 1.80100 | 34.92 |
| 18) | −75.8947 | D18 | | |
| *19) | 32.3007 | 3.500 | 1.51680 | 64.14 |
| 20) | 59.0298 | 0.200 | | |
| 21) | 42.1175 | 5.000 | 1.59319 | 67.90 |
| 22) | −136.2064 | 1.741 | 1.72047 | 34.71 |
| 23) | −228.7783 | D23 | | |
| 24) | 41.7423 | 1.200 | 1.85451 | 25.15 |
| 25) | 21.6999 | 6.682 | 1.49782 | 82.57 |
| 26) | −240.2934 | 0.200 | | |
| 27) | 76.7885 | 2.000 | 1.85108 | 40.12 |
| *28) | 108.2756 | D28 | | |
| 29) | 111.2012 | 1.200 | 1.95000 | 29.37 |
| 30) | 17.1778 | 3.739 | 1.94595 | 17.98 |
| 31) | 29.4041 | D31 | | |
| *32) | −46.3988 | 1.200 | 1.85108 | 40.12 |
| 33) | −80.8980 | 0.200 | | |
| 34) | 57.3607 | 5.500 | 1.57501 | 41.50 |
| 35) | 1745.7962 | D35 | | |

[Aspherical surface data]

| m | K | A4 | A6 | A8 | A10 | A12 |
|---|---|---|---|---|---|---|
| 6) | 1.0000 | 1.519E−06 | −2.184E−10 | 1.352E−12 | −1.201E−15 | 9.425E−18 |
| 15) | 1.0000 | −6.645E−07 | 1.393E−09 | −3.960E−12 | | |
| 19) | 1.0000 | −2.186E−07 | −1.597E−09 | −1.186E−12 | | |
| 28) | 1.0000 | 1.109E−05 | 1.403E−08 | 8.343E−12 | 1.499E−13 | |
| 32) | 1.0000 | −1.684E−06 | 8.599E−10 | 3.075E−12 | 6.087E−16 | |

[Focal length data of groups]

| Groups | First surfaces | Focal lengths |
|---|---|---|
| G1 | 1 | 96.71 |
| G2 | 6 | −23.18 |
| G3 | 14 | 136.52 |
| G4 | 19 | 43.42 |
| G5 | 24 | 105.09 |
| G6 | 29 | −43.14 |
| G7 | 32 | 469.29 |

[Variable spacing data]

| | At focusing on infinity | | | At focusing nearby | | |
|---|---|---|---|---|---|---|
| | Wide-angle | Midpoint | Telephoto | Wide-angle | Midpoint | Telephoto |
| D5 | 1.619 | 20.213 | 32.811 | 1.619 | 20.213 | 32.811 |
| D13 | 33.925 | 15.331 | 2.733 | 33.925 | 15.331 | 2.733 |
| D17 | 18.781 | 3.212 | 2.000 | 18.781 | 3.212 | 2.000 |
| D24 | 2.382 | 2.449 | 2.000 | 2.382 | 2.449 | 2.000 |
| D27 | 2.394 | 4.128 | 8.760 | 2.777 | 4.750 | 9.887 |
| D33 | 20.417 | 34.186 | 31.215 | 20.035 | 33.564 | 30.087 |
| D35 | 15.440 | 15.449 | 15.451 | 15.440 | 15.449 | 15.451 |

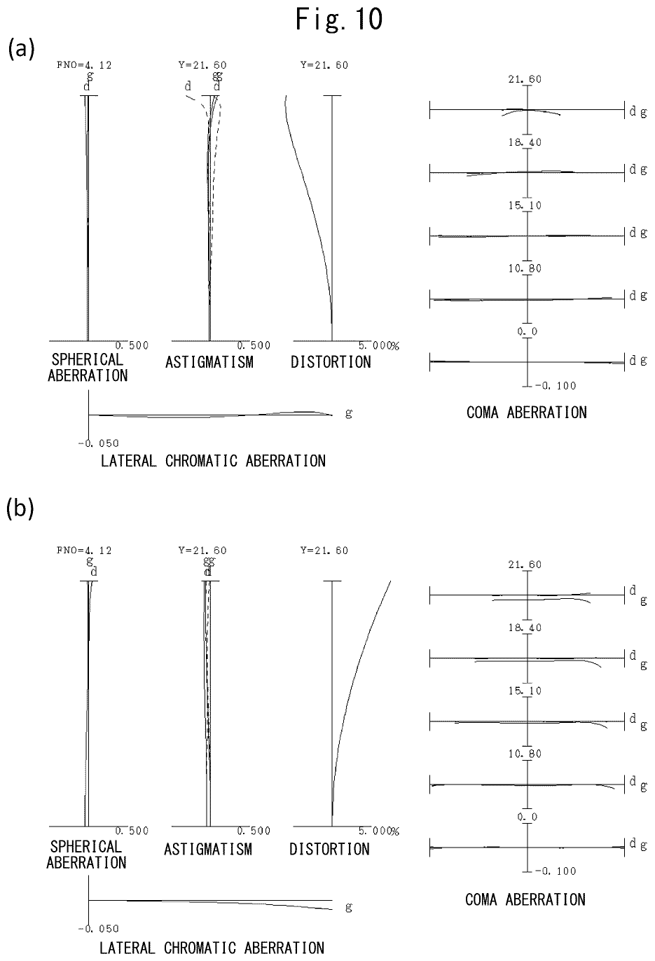

FIG. 10A shows aberrations of the variable magnification optical system of the fifth example focusing on an object at infinity in the wide-angle end state: FIG. 10B shows aberrations of the variable magnification optical system of the fifth example focusing on an object at infinity in the telephoto end state.

The graphs of aberrations suggest that the variable magnification optical system of the present example corrects aberrations appropriately and has high optical performance.

### Sixth Example

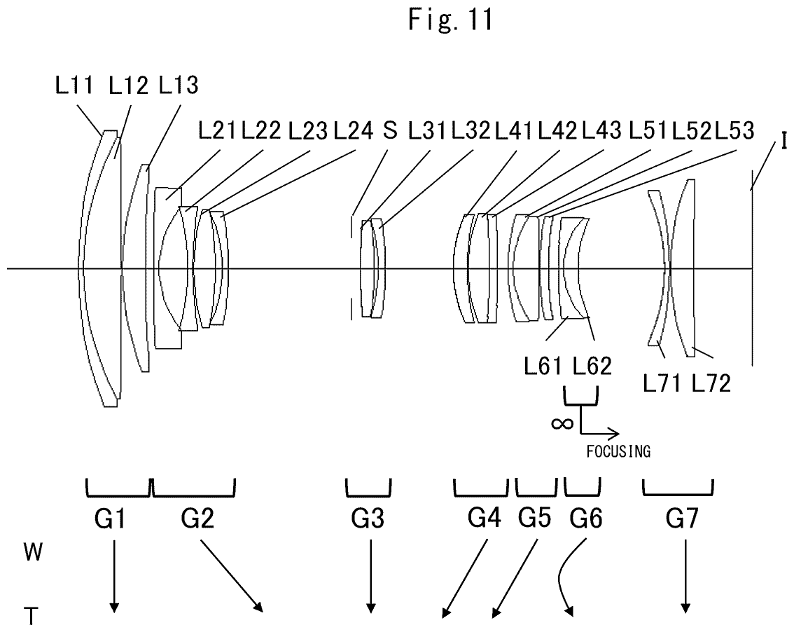

FIG. 11 is a cross-sectional view of a variable magnification optical system of a sixth example focusing on an object at infinity in the wide-angle end state.

The variable magnification optical system of the present example includes, in order from the object side, a first lens group G1 having positive refractive power, a second lens group G2 having negative refractive power, a third lens group G3 having positive refractive power, a fourth lens group G4 having positive refractive power, a fifth lens group G5 having positive refractive power, a sixth lens group G6 having negative refractive power, and a seventh lens group G7 having positive refractive power.

The first lens group G1 consists of, in order from the object side, a positive cemented lens composed of a meniscus-shaped negative lens L11 convex on the object side and a biconvex positive lens L12, and a meniscus-shaped positive lens L13 convex on the object side.

The second lens group G2 consists of, in order from the object side, a meniscus-shaped negative lens L21 convex on the object side, a biconcave negative lens L22, a biconvex positive lens L23, and a meniscus-shaped negative lens L24 concave on the object side.

The third lens group G3 consists of, in order from the object side, an aperture stop S, a biconvex positive lens L31, and a meniscus-shaped negative lens L32 concave on the object side.

The fourth lens group G4 consists of, in order from the object side, a meniscus-shaped positive lens L41 convex on the object side and a positive cemented lens composed of a biconvex positive lens L42 and a meniscus-shaped negative lens L43 concave on the object side.

The fifth lens group G5 consists of a positive cemented lens composed of a meniscus-shaped negative lens L51 convex on the object side and a biconvex positive lens L52, and a meniscus-shaped positive lens L53 convex on the object side.

The sixth lens group G6 consists of a negative cemented lens composed of a meniscus-shaped negative lens L61 convex on the object side and a meniscus-shaped positive lens L62 convex on the object side.

The seventh lens group G7 consists of, in order from the object side, a meniscus-shaped negative lens L71 concave on the object side and a meniscus-shaped positive lens L72 convex on the object side.

An imaging device (not shown) constructed from CCD, CMOS, or the like is disposed on an image plane I.

The variable magnification optical system of the present example focuses by moving the sixth lens group G6 along the optical axis. When focus is shifted from infinity to a nearby object, the sixth lens group G6 moves from the object side toward the image plane side.

In the variable magnification optical system of the present example, the fourth, fifth, sixth, and seventh lens groups G4, G5, G6, and G7 correspond to the subsequent lens group; the sixth lens group G6 corresponds to the focusing lens group: the seventh lens group G7 corresponds to the final lens group. The fourth lens group G4 corresponds to the lens group having the strongest refractive power of lens groups included in the subsequent lens group and having positive refractive power.

Table 6 below shows specifications of the variable magnification optical system of the present example.

TABLE 6
[General specifications]

| | |
|---|---|
| TL | 157.46 |
| fw | 28.84 |
| ft | 101.85 |
| FNOw | 4.12 |
| FNOt | 4.12 |
| ωw | 38.51 |
| ωt | 11.15 |
| Y | 21.60 |

[lens specifications]

| m | r | d | nd | vd |
|---|---|---|---|---|
| 1) | 89.9694 | 1.200 | 1.85451 | 25.15 |
| 2) | 61.8344 | 8.870 | 1.49782 | 82.57 |
| 3) | −1810.4849 | 0.200 | | |
| 4) | 64.2354 | 5.370 | 1.59319 | 67.90 |
| 5) | 290.2968 | D5 | | |
| *6) | 5724.0693 | 1.200 | 1.77387 | 47.25 |
| 7) | 22.3009 | 6.722 | | |
| 8) | −51.4759 | 1.200 | 1.87070 | 40.74 |
| 9) | 89.5799 | 0.200 | | |
| 10) | 48.1451 | 4.981 | 1.84666 | 23.80 |
| 11) | −65.5885 | 1.692 | | |
| 12) | −29.8981 | 1.362 | 1.59319 | 67.90 |
| 13) | −78.5606 | D13 | | |
| 14) | ∞ | 2.000 | | (aperture stop) |
| *15) | 120.1934 | 3.278 | 1.74310 | 49.44 |
| 16) | −65.7245 | 0.960 | | |
| 17) | −35.0667 | 1.651 | 1.85026 | 32.35 |
| 18) | −62.4547 | D18 | | |
| *19) | 29.6539 | 3.262 | 1.51680 | 64.14 |
| 20) | 48.4068 | 0.200 | | |
| 21) | 35.8637 | 5.000 | 1.59319 | 67.90 |
| 22) | −160.1358 | 1.853 | 1.80000 | 29.84 |
| 23) | −240.2036 | D23 | | |
| 24) | 41.9624 | 1.200 | 1.85451 | 25.15 |
| 25) | 21.1993 | 6.047 | 1.49782 | 82.57 |
| 26) | −424.5511 | 0.200 | | |
| 27) | 68.6284 | 2.079 | 1.85108 | 40.12 |
| *28) | 114.7292 | D28 | | |
| 29) | 89.8202 | 1.200 | 1.95000 | 29.37 |
| 30) | 16.6762 | 3.424 | 1.94595 | 17.98 |
| 31) | 26.9989 | D31 | | |
| *32) | −40.8570 | 1.200 | 1.85108 | 40.12 |
| 33) | −66.9608 | 0.200 | | |
| 34) | 54.9466 | 5.500 | 1.54814 | 45.79 |
| 35) | 1434.5246 | D35 | | |

[Aspherical surface data]

| m | K | A4 | A6 | A8 | A10 | A12 |
|---|---|---|---|---|---|---|
| 6) | 1.0000 | 2.611E−06 | −9.668E−10 | 4.188E−13 | 1.205E−14 | −8.027E−18 |
| 15) | 1.0000 | −3.471E−07 | 1.740E−09 | −3.975E−12 | | |
| 19) | 1.0000 | −3.712E−07 | −1.673E−09 | −2.490E−12 | | |
| 28) | 1.0000 | 1.466E−05 | 2.424E−08 | 2.676E−12 | 3.610E−13 | |
| 32) | 1.0000 | −1.048E−06 | 5.180E−09 | −4.595E−12 | 1.454E−14 | |

[Focal length data of groups]

| Groups | First surfaces | Focal lengths |
|---|---|---|
| G1 | 1 | 90.07 |
| G2 | 6 | −22.46 |
| G3 | 14 | 140.83 |
| G4 | 19 | 40.35 |
| G5 | 24 | 101.24 |
| G6 | 29 | −41.95 |
| G7 | 32 | 557.85 |

[Variable spacing data]

| | At focusing on infinity | | | At focusing nearby | | |
|---|---|---|---|---|---|---|
| | Wide-angle | Midpoint | Telephoto | Wide-angle | Midpoint | Telephoto |
| D5 | 1.995 | 19.531 | 28.874 | 1.995 | 19.531 | 28.874 |
| D13 | 28.880 | 11.344 | 2.000 | 28.880 | 11.344 | 2.000 |
| D18 | 15.834 | 2.061 | 2.000 | 15.834 | 2.061 | 2.000 |
| D23 | 2.490 | 2.378 | 2.000 | 2.490 | 2.378 | 2.000 |
| D28 | 2.241 | 4.303 | 7.661 | 2.633 | 4.962 | 8.708 |
| D31 | 20.172 | 31.996 | 29.078 | 19.781 | 31.337 | 28.030 |
| D35 | 13.601 | 13.592 | 13.628 | 13.601 | 13.592 | 13.628 |

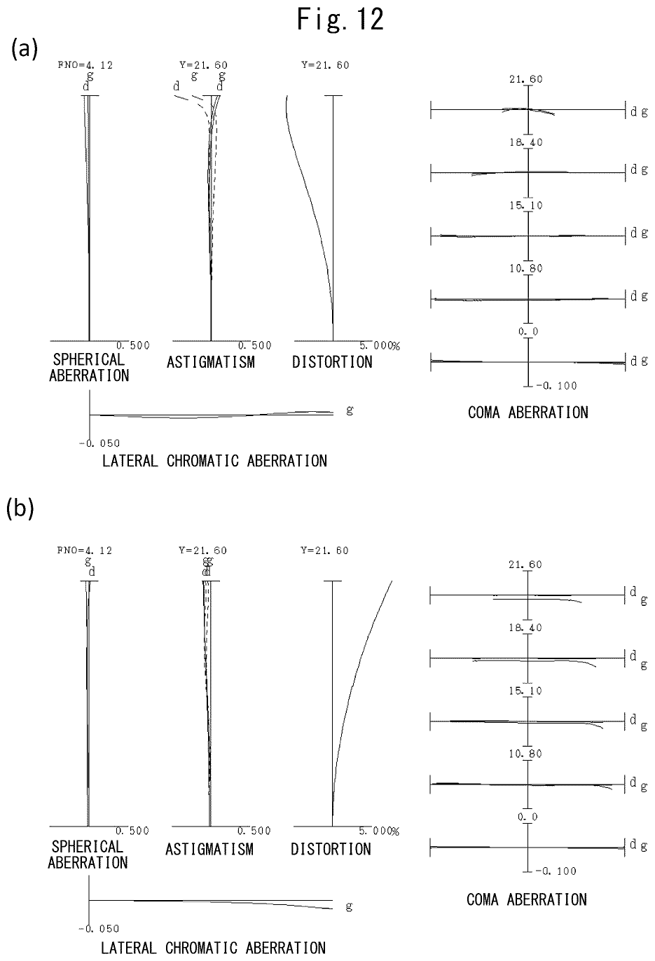

FIG. 12A shows aberrations of the variable magnification optical system of the sixth example focusing on an object at infinity in the wide-angle end state; FIG. 12B shows aberrations of the variable magnification optical system of the sixth example focusing on an object at infinity in the telephoto end state.

The graphs of aberrations suggest that the variable magnification optical system of the present example corrects aberrations appropriately and has high optical performance.

A variable magnification optical system of favorable optical performance can be achieved according to the above examples.

Values for the conditional expressions of the examples are listed below.

TL is the distance from a lens surface closest to the object side to the image plane: fw is the focal length of the variable magnification optical system in a wide-angle end state: ft is the focal length of the variable magnification optical system in a telephoto end state. f1, f2, and f3 are the focal lengths of the first, second, and third lens groups, respectively. fF is the focal length of the focusing lens group: fR is the focal length of the final lens group: fRP is the focal length of a lens group having the strongest refractive power of lens groups included in the subsequent lens group and having positive refractive power. BFw is the back focal length of the variable magnification optical system focusing on infinity in the wide-angle end state: BFt is the back focal length of the variable magnification optical system focusing on infinity in the telephoto end state. Gw is the distance from the lens surface closest to the object side in the variable magnification optical system in the wide-angle end state to the centroid position of the variable magnification optical system: Gt is the distance from the lens surface closest to the object side in the variable magnification optical system in the telephoto end state to the centroid position of the variable magnification optical system. ωw is the semi-field angle of the variable magnification optical system in the wide-angle end state; ωt is the semi-field angle of the variable magnification optical system in the telephoto end state.

### [Values for Conditional Expressions]

| Conditional | | | | | | |
|---|---|---|---|---|---|---|
| expressions | First | Second | Third | Fourth | Fifth | Sixth |
| (1) (TL/f1)/ | 0.440 | 0.433 | 0.374 | 0.407 | 0.434 | 0.495 |
| (ft/fw) | | | | | | |
| (2) f1/(−f2) | 5.348 | 5.304 | 4.321 | 4.138 | 4.172 | 4.011 |
| (3) f1/f3 | 3.767 | 3.809 | 0.781 | 1.088 | 0.708 | 0.640 |
| (4) f2/fF | 0.650 | 0.673 | 0.529 | 0.386 | 0.537 | 0.535 |
| (5) \|fR\|/(−fF) | 3.602 | 2.880 | 7.858 | 53.979 | 10.878 | 13.297 |
| (6) BFw/fw | 0.619 | 0.878 | 0.652 | 0.467 | 0.535 | 0.472 |
| (7) BFt/ft | 0.136 | 0.193 | 0.144 | 0.103 | 0.133 | 0.134 |
| (8) f1/fRP | 0.965 | 1.239 | 2.967 | 2.164 | 2.227 | 2.232 |
| (9) Gw/Gt | 0.937 | 0.913 | 0.917 | 0.939 | 0.925 | 0.937 |
| (10) ωw | 38.458° | 38.547° | 38.544° | 38.541° | 38.523° | 38.515° |
| (11) ωt | 8.677° | 8.678° | 8.715° | 8.694° | 9.795° | 11.148° |

The above examples are specific examples of the present invention, and the present invention is not limited thereto. The following features can be appropriately employed unless the optical performance of the variable magnification optical system of the embodiment of the present application is compromised.

In the variable magnification optical system of the present embodiment, the third lens group need not necessarily include an aperture stop. The position of the aperture stop in the variable magnification optical system of the present embodiment is not limited to any of the positions of the aperture stops S in the variable magnification optical systems of the above examples. The aperture stop in the variable magnification optical system of the present embodiment may be disposed between lenses in the third lens group.

The variable magnification optical system of the present embodiment may include an optical member, such as a filter, between the image plane and a lens surface closest to the image plane.

The variable magnification optical system of the present embodiment may include a vibration reduction lens group configured to make a movement including a component in a direction perpendicular to the optical axis to correct an image blur caused by shaky hands. The vibration reduction lens group may be a lens group or a lens subgroup consisting of one or more lens components included in a lens group.

In the variable magnification optical system of the present embodiment, lens surfaces may be spherical, plane, or aspherical surfaces. Spherical or plane lens surfaces are preferable because they facilitate lens machining, assembling, and adjustment and prevent a decrease in optical performance caused by errors in machining, assembling, and adjustment and because depiction performance does not decrease much when the image plane is shifted.

An aspherical lens surface may be formed by grinding glass or glass molding with a mold having an aspherical shape, or formed on the surface of resin bonded on a glass surface. In the variable magnification optical system of the present embodiment, lens surfaces may be diffractive surfaces, and lenses may be graded index lenses (GRIN lenses) or plastic lenses.

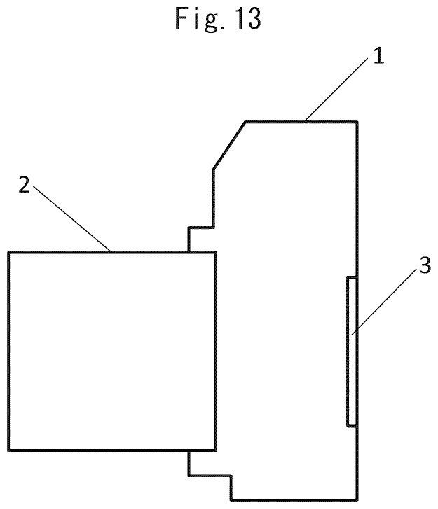

Next, a camera including the variable magnification optical system of the present embodiment will be described with reference to FIG. 13.

FIG. 13 schematically shows a camera including the variable magnification optical system of the present embodiment.

The camera 1 is a “mirror-less camera” of an interchangeable lens type including the optical system of the first example as an imaging lens 2.

In the camera 1, light from an object (subject) (not shown) is condensed by the imaging lens 2 and reaches an imaging device 3. The imaging device 3 converts the light from the subject to image data. When a release button (not shown) is pressed by a user who takes a photograph, the image data is stored in a memory (not shown). In this way, the user can take a picture of the subject with the camera 1.

The variable magnification optical system of the first example included in the camera 1 as the imaging lens 2 is a variable magnification optical system of favorable optical performance. Thus the camera 1 can achieve favorable optical performance. A camera configured by including any of the variable magnification optical systems of the second to sixth examples as the imaging lens 2 can have the same effect as the camera 1.

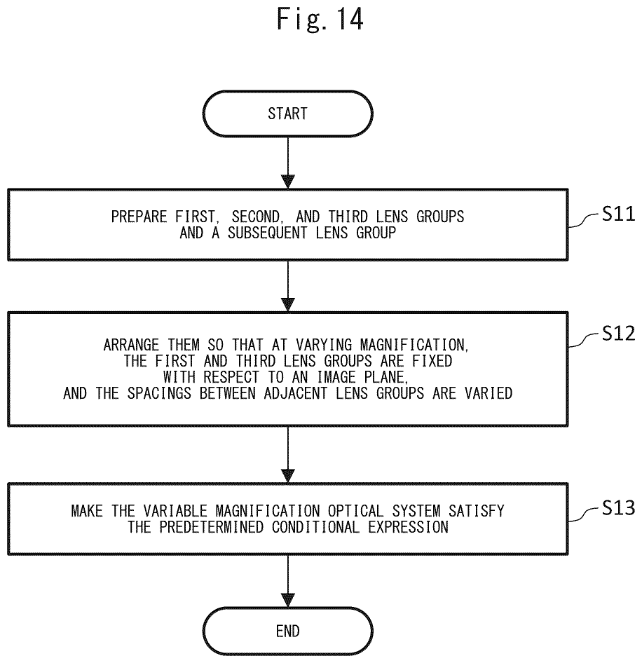

Finally, a method for manufacturing a variable magnification optical system of the present embodiment will be outlined with reference to FIG. 14.

FIG. 14 is a flowchart outlining a method for manufacturing a variable magnification optical system of the present embodiment. The method for manufacturing a variable magnification optical system of the present embodiment shown in FIG. 14 includes steps S11 to S13 below.

Step S11: first, second, and third lens groups and a subsequent lens group are prepared.

Step S12: they are arranged so that at varying magnification, the first and third lens groups are fixed with respect to an image plane, and the spacings between adjacent lens groups are varied.

Step S13: the variable magnification optical system is made to satisfy the following conditional expression.

$$0.24 < ( TL / f 1 ) / ( ft / fw ) < 0.55 \qquad ( 1 )$$

where
TL: the distance from a lens surface closest to the object side to the image plane
f1: the focal length of the first lens group
ft: the focal length of the variable magnification optical system in a telephoto end state
fw: the focal length of the variable magnification optical system in a wide-angle end state

An optical system of favorable imaging performance can be manufactured by the method for manufacturing a variable magnification optical system of the present embodiment.

It should be noted that those skilled in the art can make various changes, substitutions, and modifications without departing from the spirit and scope of the present disclosure.

What is claimed is:

1. A variable magnification optical system comprising, in order from an object side, a first lens group having positive refractive power, a second lens group having negative refractive power, a third lens group having positive refractive power, and a subsequent lens group including a plurality of lens groups,
at varying magnification, the first and third lens groups being fixed with respect to an image plane, and the spacings between adjacent lens groups being varied,
the variable magnification optical system satisfying the following conditional expression.
$$0.24 < ( TL / f 1 ) / ( ft / fw ) < 0.55$$
where
TL: the distance from a lens surface closest to the object side to the image plane
f1: the focal length of the first lens group
ft: the focal length of the variable magnification optical system in a telephoto end state
fw: the focal length of the variable magnification optical system in a wide-angle end state

2. The variable magnification optical system according to claim 1, wherein the following conditional expression is satisfied.
$$3. < f 1 / ( - f 2 ) < 5.8$$
where
f2: the focal length of the second lens group

3. The variable magnification optical system according to claim 1, wherein the following conditional expression is satisfied.
$$0.45 < f 1 / f 3 < 6.$$
where
f3: the focal length of the third lens group

4. The variable magnification optical system according to claim 1, wherein the subsequent lens group includes a focusing lens group having negative refractive power and moving at focusing, and the following conditional expression is satisfied.
$$0.3 < f 2 / fF < 1.$$
where
f2: the focal length of the second lens group
fF: the focal length of the focusing lens group

5. The variable magnification optical system according to claim 1, wherein a final lens group disposed closest to the image plane in the subsequent lens group is fixed with respect to the image plane at varying magnification.

6. The variable magnification optical system according to claim 1, wherein the subsequent lens group includes a focusing lens group having negative refractive power and moving at focusing and a final lens group disposed closest to the image plane, and
the following conditional expression is satisfied.
$$2. < \vert fR \vert / ( - fF ) < 100.$$
where
fR: the focal length of the final lens group
fF: the focal length of the focusing lens group

7. The variable magnification optical system according to claim 1, wherein the following conditional expression is satisfied.
$$0.15 < BFw / fw < 0.95$$
where
BFw: the back focal length of the variable magnification optical system focusing on infinity in the wide-angle end state

8. The variable magnification optical system according to claim 1, wherein the following conditional expression is satisfied.
$$0.08 < BFt / ft < 0.24$$
where
BFt: the back focal length of the variable magnification optical system focusing on infinity in the telephoto end state

9. The variable magnification optical system according to claim 1, wherein the subsequent lens group includes at least one lens group having positive refractive power, and the following conditional expression is satisfied.
$$0.7 < f 1 / fRP < 3.4$$
where
fRP: the focal length of a lens group having the strongest refractive power of lens groups included in the subsequent lens group and having positive refractive power

10. The variable magnification optical system according to claim 1, wherein the following conditional expression is satisfied.
$$0.5 < Gw / Gt < 1.5$$
where
Gw: the distance from the lens surface closest to the object side in the variable magnification optical system in the wide-angle end state to the centroid position of the variable magnification optical system
Gt: the distance from the lens surface closest to the object side in the variable magnification optical system in the telephoto end state to the centroid position of the variable magnification optical system

11. An optical device comprising the variable magnification optical system according to claim 1.

12. A method for manufacturing a variable magnification optical system, the method comprising configuring a variable magnification optical system including, in order from an object side, a first lens group having positive refractive power, a second lens group having negative refractive power, a third lens group having positive refractive power, and a subsequent lens group including a plurality of lens groups so that
at varying magnification, the first and third lens groups are fixed with respect to an image plane, and the spacings between adjacent lens groups are varied, and
the following conditional expression is satisfied.
$$0.24 < ( TL / f 1 ) / ( ft / fw ) < 0.55$$
where
TL: the distance from a lens surface closest to the object side to the image plane
f1: the focal length of the first lens group
ft: the focal length of the variable magnification optical system in a telephoto end state
fw: the focal length of the variable magnification optical system in a wide-angle end state
